(19) United States
(12) Patent Application Publication
(10) Pub. No.: US 2024/0385795 A1
(43) Pub. Date: Nov. 21, 2024

(54) TECHNIQUES FOR MANAGING ONE OR MORE DISPLAYS

(71) Applicant: Apple Inc., Cupertino, CA (US)

(72) Inventors: Gregory F. HUGHES, San Jose, CA (US); Cheng-Kai CHEN, Sunnyvale, CA (US); Chia-Hao CHEN, San Jose, CA (US)

(21) Appl. No.: 18/623,717

(22) Filed: Apr. 1, 2024

Related U.S. Application Data
(60) Provisional application No. 63/466,682, filed on May 15, 2023.

(51) Int. Cl. G06F 3/14; G06F 3/01; G06F 3/02; G06F 3/04845

(52) U.S. Cl. CPC G06F 3/1423; G06F 3/013; G06F 3/02; G06F 3/04845

(57) ABSTRACT

The present disclosure generally relates to managing one or more displays. In particular, methods for moving an indicator between displays, moving an indicator based on body movement, and managing display operations are discussed herein.

### CROSS-REFERENCE TO RELATED APPLICATIONS

The present application claims priority to U.S. Provisional Patent Application Ser. No. 63/466,682 entitled “TECHNIQUES FOR MANAGING ONE OR MORE DISPLAYS,” filed May 15, 2023, which is hereby incorporated by reference in its entirety for all purposes.

### FIELD

The present disclosure relates generally to computer user interfaces, and more specifically to techniques for managing one or more displays.

### BACKGROUND

Computer systems often operate with different displays. Some displays can be configured to operate at a particular zoom level while displaying content.

### SUMMARY

Some techniques for managing one or more displays using computer systems, however, are generally cumbersome and inefficient. For example, some existing techniques use a complex and time-consuming user interface, which may require multiple key presses or keystrokes to perform desired operations. Existing techniques require more time than necessary, wasting user time and device energy. This latter consideration is particularly important in battery-operated devices.

Accordingly, the present technique provides computer systems with faster, more efficient methods and interfaces for managing one or more displays. Such methods and interfaces optionally complement or replace other methods for managing one or more displays. Such methods and interfaces reduce the cognitive burden on a user and produce a more efficient human-machine interface. For battery-operated computing devices and/or systems, such methods and interfaces conserve power and increase the time between battery charges.

In some examples, a method that is performed at a computer system that is in communication with a first display generation component, a second display generation component different from the first display generation component, and one or more input devices is described. In some examples, the method comprises: displaying, via the first display generation component, a portion of first content and an indicator overlaid on a first location of the portion of the first content; displaying, via the second display generation component, a portion of second content; while displaying the indicator overlaid on the first location of the portion of first content, detecting, via the one or more input devices, an end of a first input; and in response to detecting the end of the first input while displaying the indicator overlaid on the first location, moving display of the indicator from overlaid on the first location of the first content displayed via the first display generation component to overlaid on a second location of the second content displayed via the second display generation component, wherein the first location of the first content is not a location corresponding to an edge of content displayed via the first display generation component.

In some examples, a non-transitory computer-readable storage medium storing one or more programs configured to be executed by one or more processors of a computer system that is in communication with a first display generation component, a second display generation component different from the first display generation component, and one or more input devices is described. In some examples, the one or more programs includes instructions for: displaying, via the first display generation component, a portion of first content and an indicator overlaid on a first location of the portion of the first content; displaying, via the second display generation component, a portion of second content; while displaying the indicator overlaid on the first location of the portion of first content, detecting, via the one or more input devices, an end of a first input; and in response to detecting the end of the first input while displaying the indicator overlaid on the first location, moving display of the indicator from overlaid on the first location of the first content displayed via the first display generation component to overlaid on a second location of the second content displayed via the second display generation component, wherein the first location of the first content is not a location corresponding to an edge of content displayed via the first display generation component.

In some examples, a transitory computer-readable storage medium storing one or more programs configured to be executed by one or more processors of a computer system that is in communication with a first display generation component, a second display generation component different from the first display generation component, and one or more input devices is described. In some examples, the one or more programs includes instructions for: displaying, via the first display generation component, a portion of first content and an indicator overlaid on a first location of the portion of the first content; displaying, via the second display generation component, a portion of second content; while displaying the indicator overlaid on the first location of the portion of first content, detecting, via the one or more input devices, an end of a first input; and in response to detecting the end of the first input while displaying the indicator overlaid on the first location, moving display of the indicator from overlaid on the first location of the first content displayed via the first display generation component to overlaid on the second location of the second content displayed via the second display generation component, wherein the first location of the first content is not a location corresponding to an edge of content displayed via the first display generation component.

In some examples, a computer system that is in communication with a first display generation component, a second display generation component different from the first display generation component, and one or more input devices is described. In some examples, the computer system comprises one or more processors and memory storing one or more program configured to be executed by the one or more processors. In some examples, the one or more programs includes instructions for: displaying, via the first display generation component, a portion of first content and an indicator overlaid on a first location of the portion of the first content; displaying, via the second display generation component, a portion of second content; while displaying the indicator overlaid on the first location of the portion of first content, detecting, via the one or more input devices, an end of a first input; and in response to detecting the end of the first input while displaying the indicator overlaid on the first location, moving display of the indicator from overload on the first location of the first content displayed via the first display generation component to overload on a second location of the second content displayed via the second display generation component, wherein the first location of the first content is not a location corresponding to an edge of content displayed via the first display generation component.

In some examples, a computer system that is in communication with a first display generation component, a second display generation component different from the first display generation component, and one or more input devices is described. In some examples, the computer system comprises means for performing each of the following steps: displaying, via the first display generation component, a portion of first content and an indicator overlaid on a first location of the portion of the first content; displaying, via the second display generation component, a portion of second content; while displaying the indicator overlaid on the first location of the portion of first content, detecting, via the one or more input devices, an end of a first input; and in response to detecting the end of the first input while displaying the indicator overlaid on the first location, moving display of the indicator from overlaid on the first location of the first content displayed via the first display generation component to overlaid on a second location of the second content displayed via the second display generation component, wherein the first location of the first content is not a location corresponding to an edge of content displayed via the first display generation component.

In some examples, a computer program product is described. In some examples, the computer program product comprises one or more programs configured to be executed by one or more processors of a computer system that is in communication with a first display generation component, a second display generation component different from the first display generation component, and one or more input devices. In some examples, the one or more programs include instructions for: displaying, via the first display generation component, a portion of first content and an indicator overlaid on a first location of the portion of the first content; displaying, via the second display generation component, a portion of second content; while displaying the indicator overlaid on the first location of the portion of first content, detecting, via the one or more input devices, an end of a first input; and in response to detecting the end of the first input while displaying the indicator overlaid on the first location, moving display of the indicator from overlaid on the first location of the first content displayed via the first display generation component to overlaid on a second location of the second content displayed via the second display generation component, wherein the first location of the first content is not a location corresponding to an edge of content displayed via the first display generation component.

In some examples, a method that is performed at a computer system is described. In some examples, the method comprises: displaying an indicator overlaid on a first location of a first area of first content; while displaying the indicator overlaid on the first location of the first area of the first content, detecting movement of a body part; and in response to detecting movement of the body part: in accordance with a determination that the body part is directed to a first area of second content, displaying the indicator overlaid on a previous location of a second area of the second content, wherein the indicator was last displayed overlaid on the previous location of the second area of the second content before the indicator was last moved from the second content, and wherein a location of the first area of the second content to which the body part is detected as being directed is different from the previous location of the second area of the second content; and in accordance with a determination that the body portion is directed to a first area of third content, displaying the indicator overlaid on a previous location of a second area of the third content, wherein the indicator was last displayed overlaid on the previous location of the second area of the third content before the indicator was last moved from the third content, and wherein a location of the first area of the third content to which the body part is detected as being directed is different from the previous location of the second area of the third content.

In some examples, a non-transitory computer-readable storage medium storing one or more programs configured to be executed by one or more processors of a computer system is described. In some examples, the one or more programs includes instructions for: displaying an indicator overlaid on a first location of a first area of first content; while displaying the indicator overlaid on the first location of the first area of the first content, detecting movement of a body part; and in response to detecting movement of the body part: in accordance with a determination that the body part is directed to a first area of second content, displaying the indicator overlaid on a previous location of a second area of the second content, wherein the indicator was last displayed overlaid on the previous location of the second area of the second content before the indicator was last moved from the second content, and wherein a location of the first area of the second content to which the body part is detected as being directed is different from the previous location of the second area of the second content; and in accordance with a determination that the body portion is directed to a first area of third content, displaying the indicator overlaid on a previous location of a second area of the third content, wherein the indicator was last displayed overlaid on the previous location of the second area of the third content before the indicator was last moved from the third content, and wherein a location of the first area of the third content to which the body part is detected as being directed is different from the previous location of the second area of the third content.

In some examples, a transitory computer-readable storage medium storing one or more programs configured to be executed by one or more processors of a computer system is described. In some examples, the one or more programs includes instructions for: displaying an indicator overlaid on a first location of a first area of first content; while displaying the indicator overlaid on the first location of the first area of the first content, detecting movement of a body part; and in response to detecting movement of the body part: in accordance with a determination that the body part is directed to a first area of second content, displaying the indicator overlaid on a previous location of a second area of the second content, wherein the indicator was last displayed overlaid on the previous location of the second area of the second content before the indicator was last moved from the second content, and wherein a location of the first area of the second content to which the body part is detected as being directed is different from the previous location of the second area of the second content; and in accordance with a determination that the body portion is directed to a first area of third content, displaying the indicator overlaid on a previous location of a second area of the third content, wherein the indicator was last displayed overlaid on the previous location of the second area of the third content before the indicator was last moved from the third content, and wherein a location of the first area of the third content to which the body part is detected as being directed is different from the previous location of the second area of the third content.

In some examples, a computer system is described. In some examples, the computer system comprises one or more processors and memory storing one or more program configured to be executed by the one or more processors. In some examples, the one or more programs includes instructions for: displaying an indicator overlaid on a first location of a first area of first content; while displaying the indicator overlaid on the first location of the first area of the first content, detecting movement of a body part; and in response to detecting movement of the body part: in accordance with a determination that the body part is directed to a first area of second content, displaying the indicator overlaid on a previous location of a second area of the second content, wherein the indicator was last displayed overlaid on the previous location of the second area of the second content before the indicator was last moved from the second content, and wherein a location of the first area of the second content to which the body part is detected as being directed is different from the previous location of the second area of the second content; and in accordance with a determination that the body portion is directed to a first area of third content, displaying the indicator overlaid on a previous location of a second area of the third content, wherein the indicator was last displayed overlaid on the previous location of the second area of the third content before the indicator was last moved from the third content, and wherein a location of the first area of the third content to which the body part is detected as being directed is different from the previous location of the second area of the third content.

In some examples, a computer system is described. In some examples, the computer system comprises means for performing each of the following steps: displaying an indicator overlaid on a first location of a first area of first content; while displaying the indicator overlaid on the first location of the first area of the first content, detecting movement of a body part; and in response to detecting movement of the body part: in accordance with a determination that the body part is directed to a first area of second content, displaying the indicator overlaid on a previous location of a second area of the second content, wherein the indicator was last displayed overlaid on the previous location of the second area of the second content before the indicator was last moved from the second content, and wherein a location of the first area of the second content to which the body part is detected as being directed is different from the previous location of the second area of the second content; and in accordance with a determination that the body portion is directed to a first area of third content, displaying the indicator overlaid on a previous location of a second area of the third content, wherein the indicator was last displayed overlaid on the previous location of the second area of the third content before the indicator was last moved from the third content, and wherein a location of the first area of the third content to which the body part is detected as being directed is different from the previous location of the second area of the third content.

In some examples, a computer program product is described. In some examples, the computer program product comprises one or more programs configured to be executed by one or more processors of a computer system. In some examples, the one or more programs include instructions for: displaying an indicator overlaid on a first location of a first area of first content; while displaying the indicator overlaid on the first location of the first area of the first content, detecting movement of a body part; and in response to detecting movement of the body part: in accordance with a determination that the body part is directed to a first area of second content, displaying the indicator overlaid on a previous location of a second area of the second content, wherein the indicator was last displayed overlaid on the previous location of the second area of the second content before the indicator was last moved from the second content, and wherein a location of the first area of the second content to which the body part is detected as being directed is different from the previous location of the second area of the second content; and in accordance with a determination that the body portion is directed to a first area of third content, displaying the indicator overlaid on a previous location of a second area of the third content, wherein the indicator was last displayed overlaid on the previous location of the second area of the third content before the indicator was last moved from the third content, and wherein a location of the first area of the third content to which the body part is detected as being directed is different from the previous location of the second area of the third content.

In some examples, a method that is performed at a computer system that is in communication with a display generation component and one or more input devices is described. In some examples, the method comprises: while operating in a first mode, displaying, via the display generation component, an indicator overlaid on content; while operating in the first mode and displaying the indicator, detecting, via one or more input devices, a first input corresponding to a first type of input; in response to detecting the first input corresponding to the first type of input, moving display of the indicator while panning the content; in conjunction with moving the display of the indicator while panning the content, detecting, via the one or more input devices, an input corresponding to a second type of input different from the first type of input; in response to detecting the input corresponding to the second type of input, configuring the computer system to operate in a second mode different from the first mode input; while operating in the second mode, detecting a second input corresponding to the first type of input; and in response to detecting the second input corresponding to the first type of input, moving the display of the indicator without panning the content.

In some examples, a non-transitory computer-readable storage medium storing one or more programs configured to be executed by one or more processors of a computer system that is in communication with a display generation component and one or more input devices is described. In some examples, the one or more programs includes instructions for: while operating in a first mode, displaying, via the display generation component, an indicator overlaid on content; while operating in the first mode and displaying the indicator, detecting, via one or more input devices, a first input corresponding to a first type of input; in response to detecting the first input corresponding to the first type of input, moving display of the indicator while panning the content; in conjunction with moving the display of the indicator while panning the content, detecting, via the one or more input devices, an input corresponding to a second type of input different from the first type of input; in response to detecting the input corresponding to the second type of input, configuring the computer system to operate in a second mode different from the first mode input; while operating in the second mode, detecting a second input corresponding to the first type of input; and in response to detecting the second input corresponding to the first type of input, moving the display of the indicator without panning the content.

In some examples, a transitory computer-readable storage medium storing one or more programs configured to be executed by one or more processors of a computer system that is in communication with a display generation component and one or more input devices is described. In some examples, the one or more programs includes instructions for: while operating in a first mode, displaying, via the display generation component, an indicator overlaid on content; while operating in the first mode and displaying the indicator, detecting, via one or more input devices, a first input corresponding to a first type of input; in response to detecting the first input corresponding to the first type of input, moving display of the indicator while panning the content; in conjunction with moving the display of the indicator while panning the content, detecting, via the one or more input devices, an input corresponding to a second type of input different from the first type of input; in response to detecting the input corresponding to the second type of input, configuring the computer system to operate in a second mode different from the first mode input; while operating in the second mode, detecting a second input corresponding to the first type of input; and in response to detecting the second input corresponding to the first type of input, moving the display of the indicator without panning the content.

In some examples, a computer system that is in communication with a display generation component and one or more input devices is described. In some examples, the computer system comprises one or more processors and memory storing one or more program configured to be executed by the one or more processors. In some examples, the one or more programs includes instructions for: while operating in a first mode, displaying, via the display generation component, an indicator overlaid on content; while operating in the first mode and displaying the indicator, detecting, via one or more input devices, a first input corresponding to a first type of input; in response to detecting the first input corresponding to the first type of input, moving display of the indicator while panning the content; in conjunction with moving the display of the indicator while panning the content, detecting, via the one or more input devices, an input corresponding to a second type of input different from the first type of input; in response to detecting the input corresponding to the second type of input, configuring the computer system to operate in a second mode different from the first mode input; while operating in the second mode, detecting a second input corresponding to the first type of input; and in response to detecting the second input corresponding to the first type of input, moving the display of the indicator without panning the content.

In some examples, a computer system that is in communication with a display generation component and one or more input devices is described. In some examples, the computer system comprises means for performing each of the following steps: while operating in a first mode, displaying, via the display generation component, an indicator overlaid on content; while operating in the first mode and displaying the indicator, detecting, via one or more input devices, a first input corresponding to a first type of input; in response to detecting the first input corresponding to the first type of input, moving display of the indicator while panning the content; in conjunction with moving the display of the indicator while panning the content, detecting, via the one or more input devices, an input corresponding to a second type of input different from the first type of input; in response to detecting the input corresponding to the second type of input, configuring the computer system to operate in a second mode different from the first mode input; while operating in the second mode, detecting a second input corresponding to the first type of input; and in response to detecting the second input corresponding to the first type of input, moving the display of the indicator without panning the content.

In some examples, a computer program product is described. In some examples, the computer program product comprises one or more programs configured to be executed by one or more processors of a computer system that is in communication with a display generation component and one or more input devices. In some examples, the one or more programs include instructions for: while operating in a first mode, displaying, via the display generation component, an indicator overlaid on content; while operating in the first mode and displaying the indicator, detecting, via one or more input devices, a first input corresponding to a first type of input; in response to detecting the first input corresponding to the first type of input, moving display of the indicator while panning the content; in conjunction with moving the display of the indicator while panning the content, detecting, via the one or more input devices, an input corresponding to a second type of input different from the first type of input; in response to detecting the input corresponding to the second type of input, configuring the computer system to operate in a second mode different from the first mode input; while operating in the second mode, detecting a second input corresponding to the first type of input; and in response to detecting the second input corresponding to the first type of input, moving the display of the indicator without panning the content.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for managing one or more displays, thereby increasing the effectiveness, efficiency, and user satisfaction with such devices. Such methods and interfaces may complement or replace other methods for managing one or more displays.

### DESCRIPTION OF THE FIGURES

For a better understanding of the various described examples, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some examples.

FIG. 1B is a block diagram illustrating exemplary components for event handling in accordance with some examples.

FIG. 2 illustrates a portable multifunction device having a touch screen in accordance with some examples.

FIG. 3 is a block diagram of an exemplary multifunction device with a display and a touch-sensitive surface in accordance with some examples.

FIG. 4A illustrates an exemplary user interface for a menu of applications on a portable multifunction device in accordance with some examples.

FIG. 4B illustrates an exemplary user interface for a multifunction device with a touch-sensitive surface that is separate from the display in accordance with some examples.

FIG. 5A illustrates a personal electronic device in accordance with some examples.

FIG. 5B is a block diagram illustrating a personal electronic device in accordance with some examples.

FIGS. 6A-6AK illustrate exemplary user interfaces for managing one or more displays in accordance with some examples.

FIG. 7 is a flow diagram illustrating a method for moving an indicator between displays in accordance with some examples.

FIG. 8 is a flow diagram illustrating a method for moving an indicator based on body movement in accordance with some examples.

FIG. 9 is a flow diagram illustrating a method for managing display operations in accordance with some examples.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for managing one or more displays. Such techniques can reduce the cognitive burden on a user who use computer systems with displays, thereby enhancing productivity. Further, such techniques can reduce processor and battery power otherwise wasted on redundant user inputs.

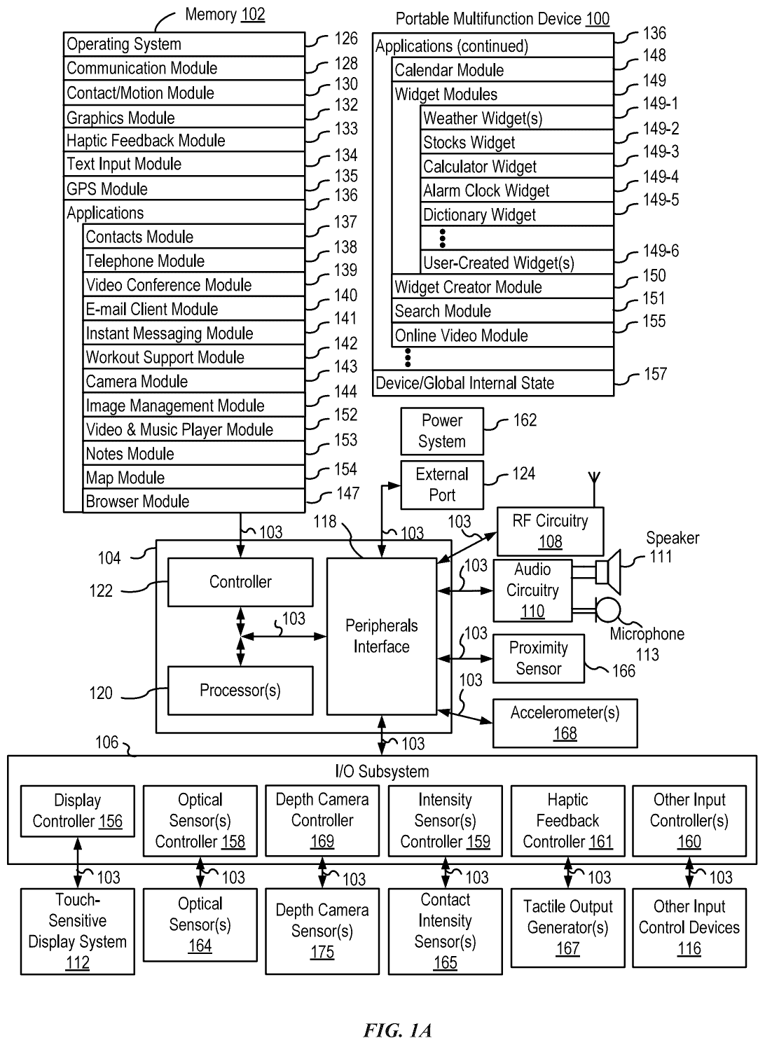

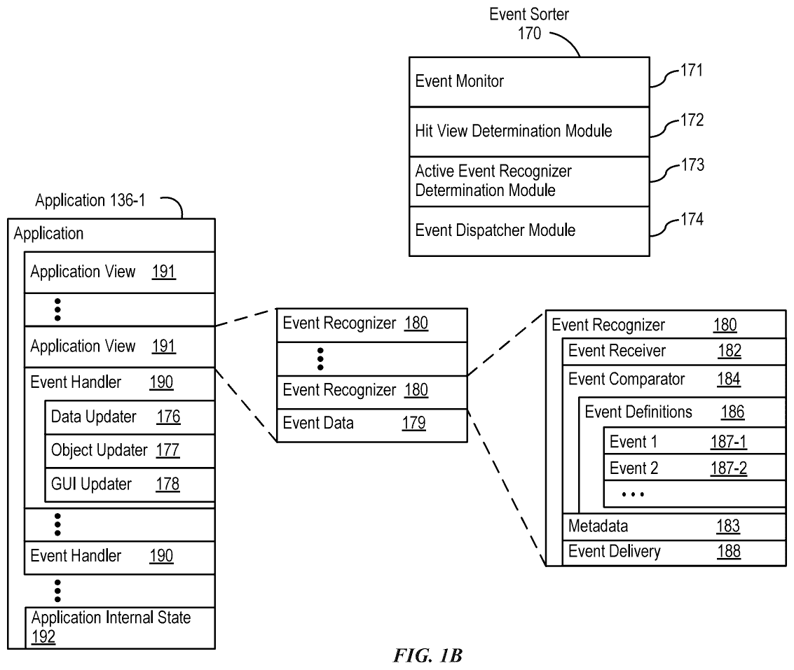

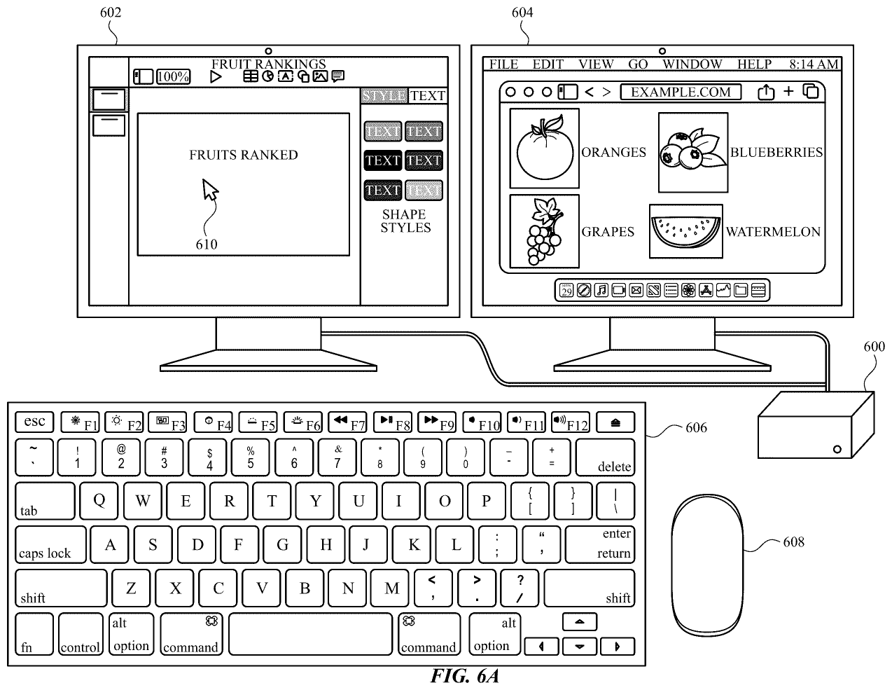

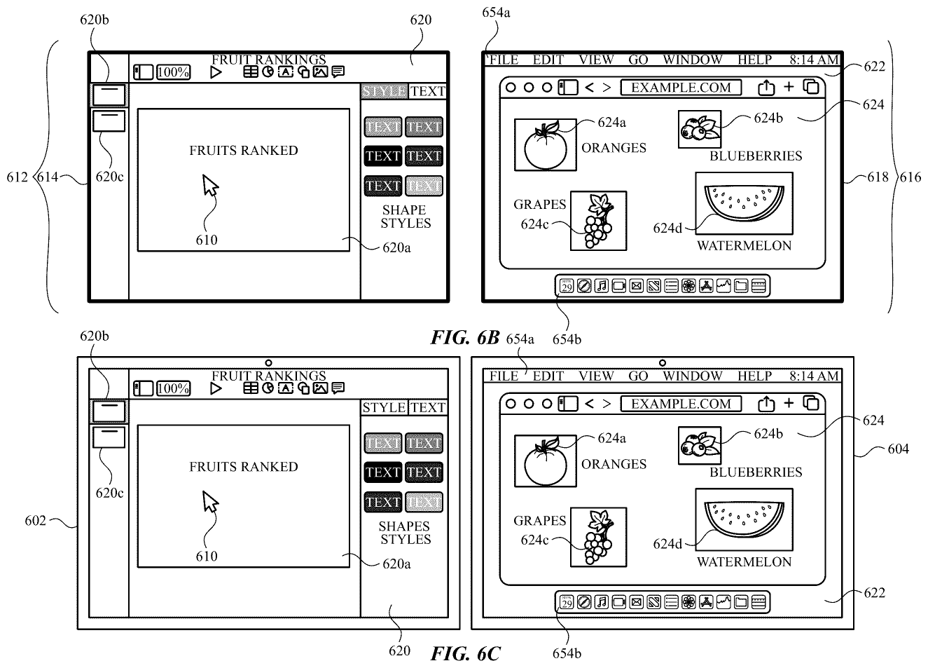

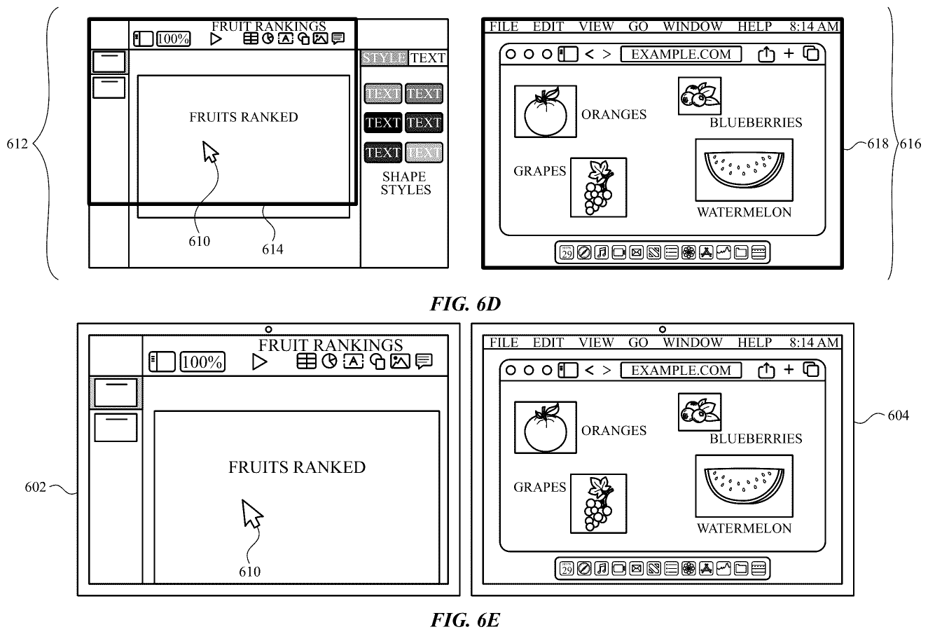

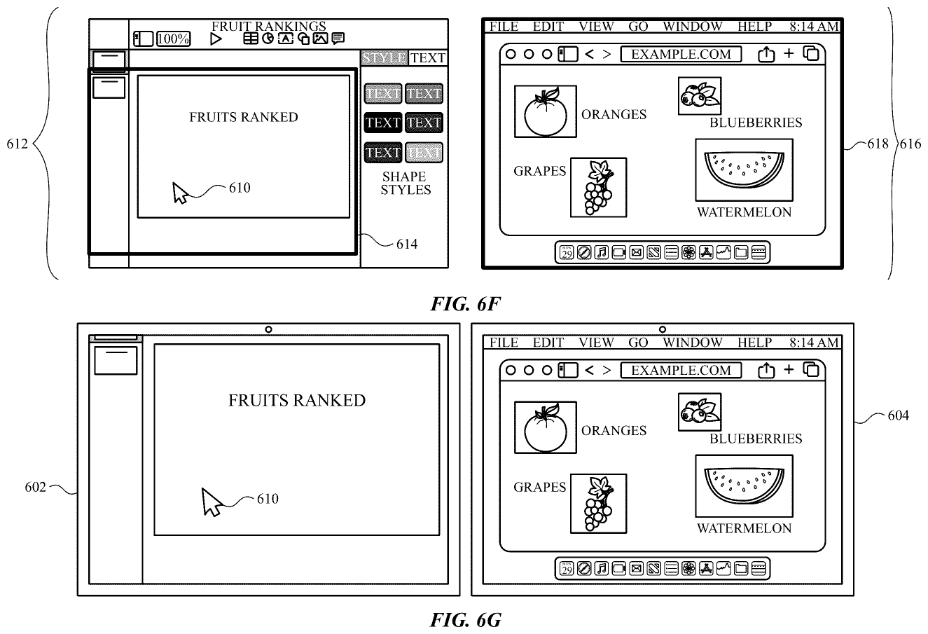

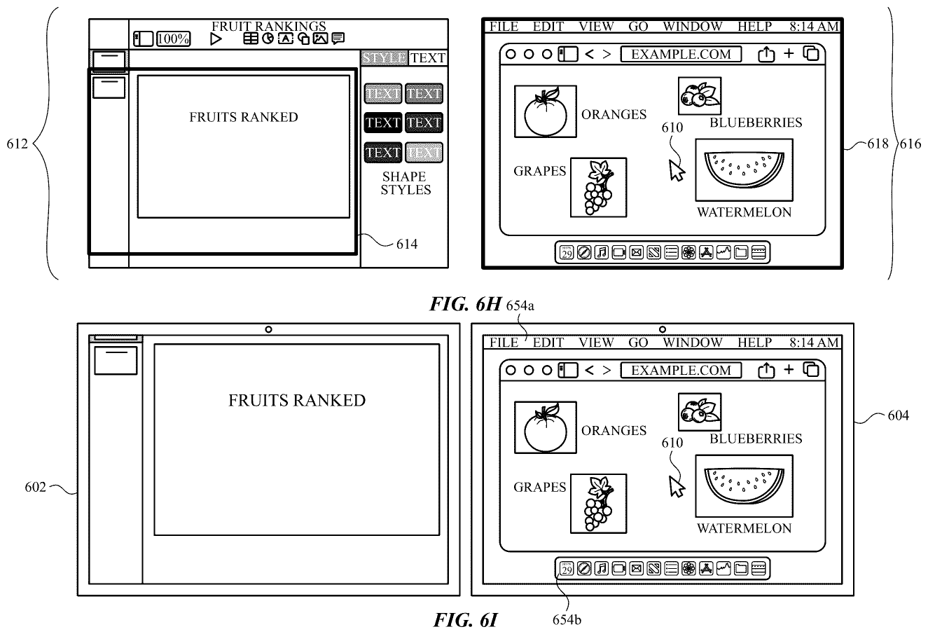

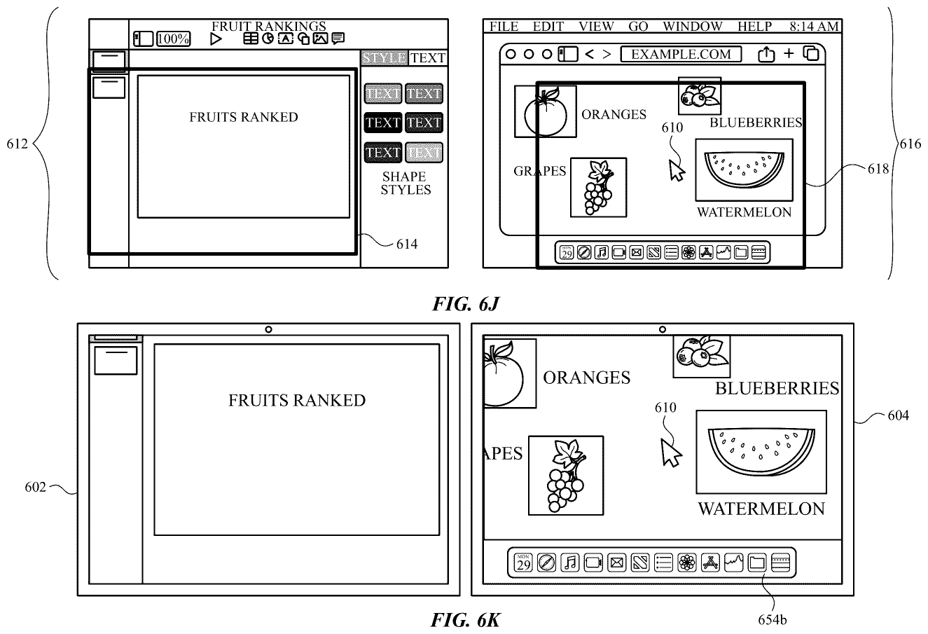

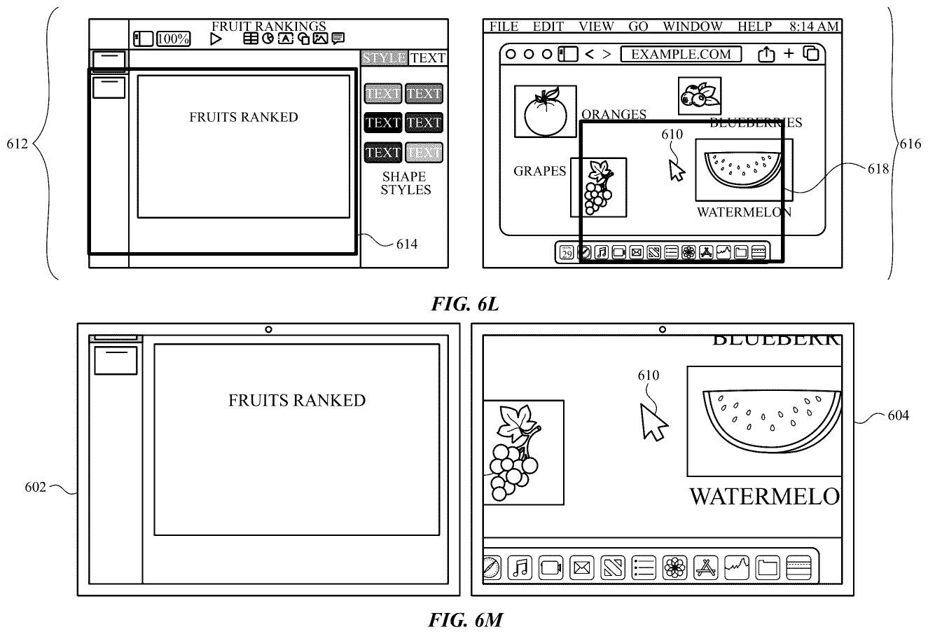

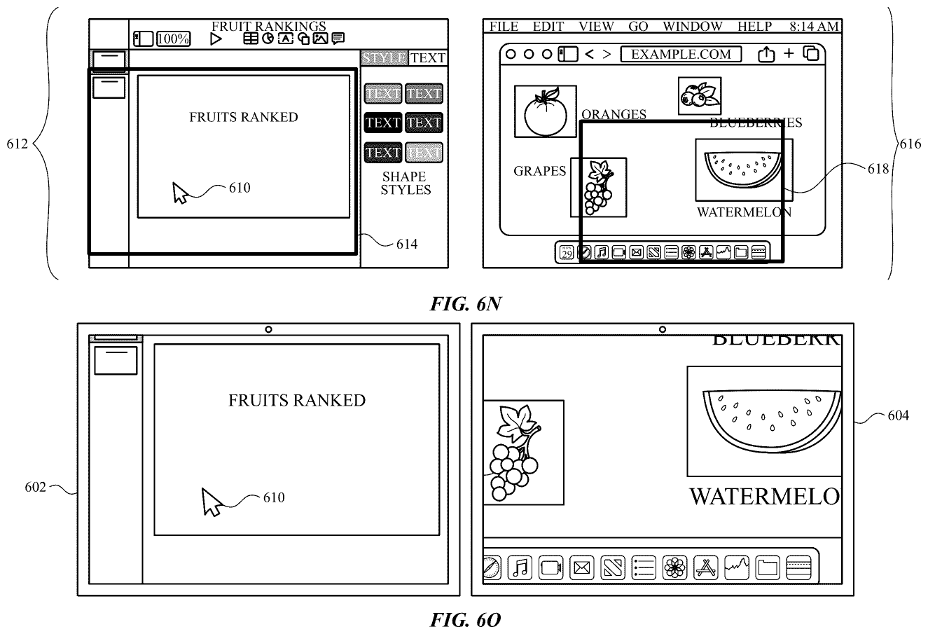

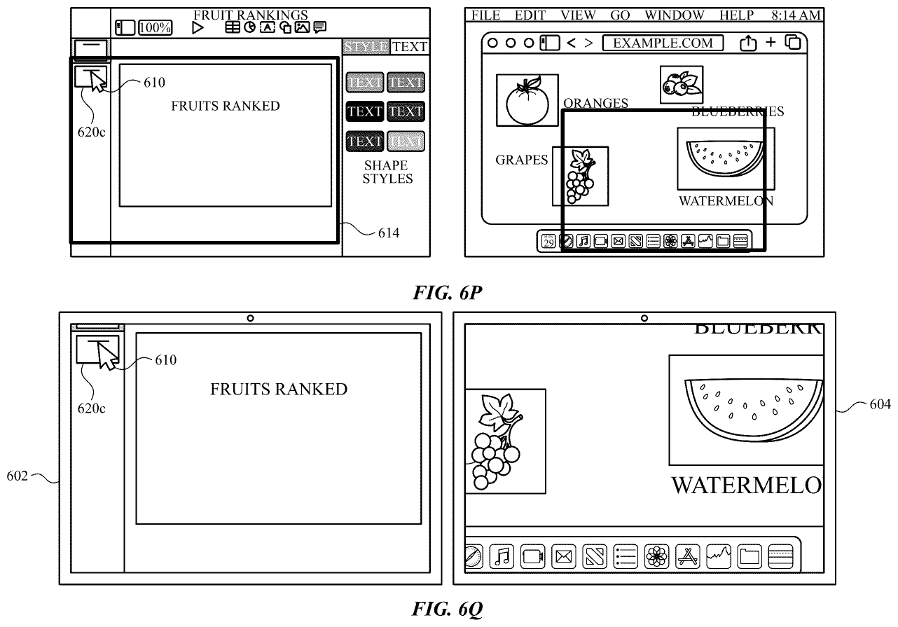

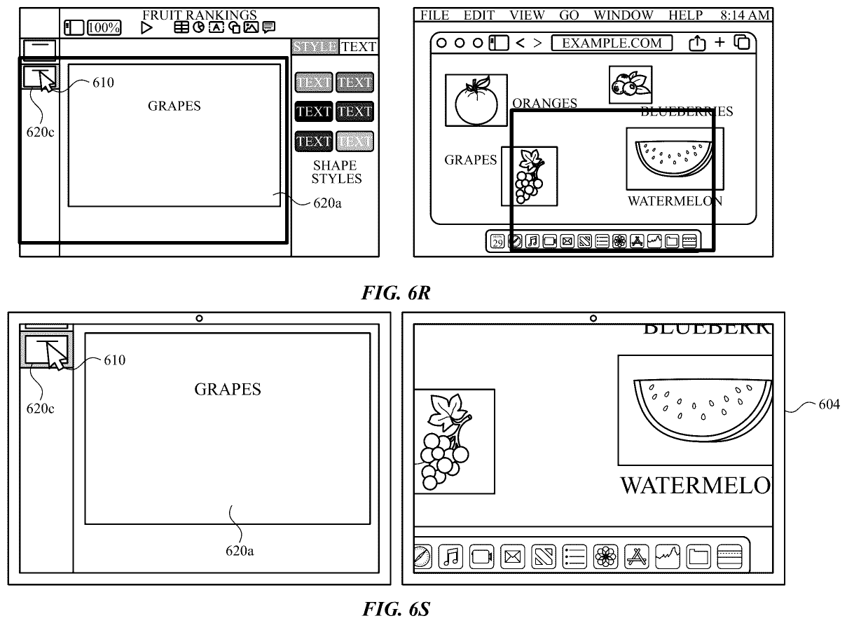

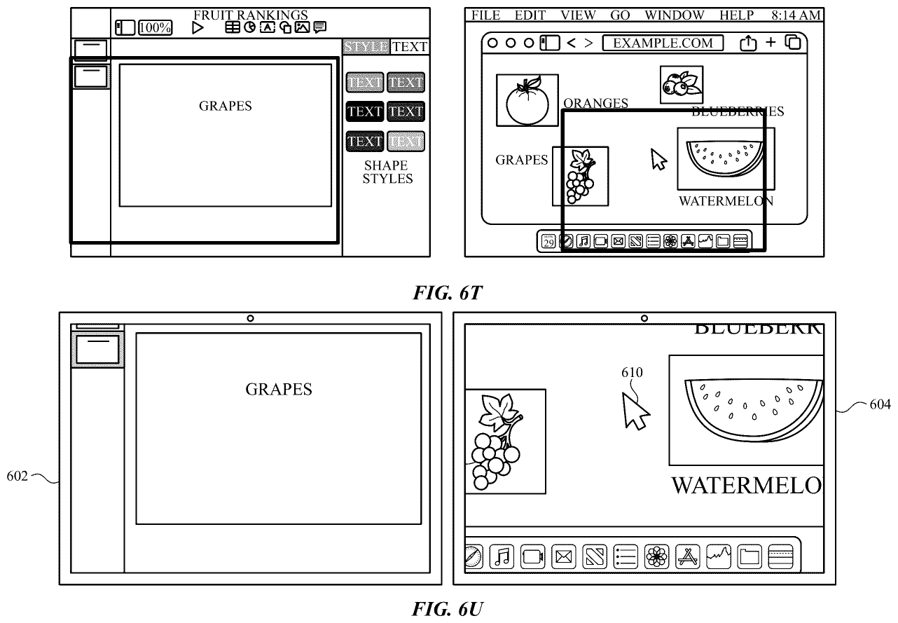

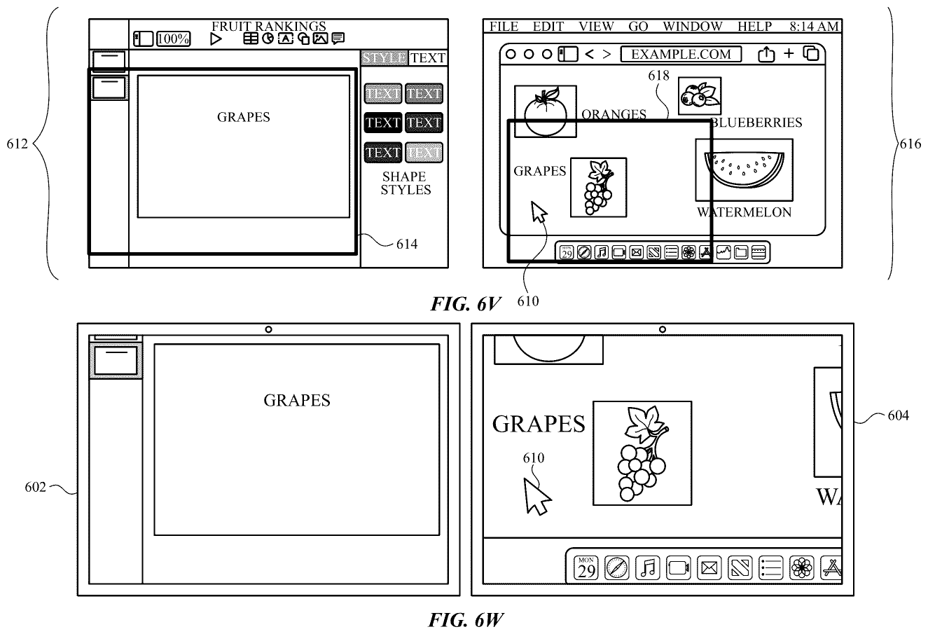

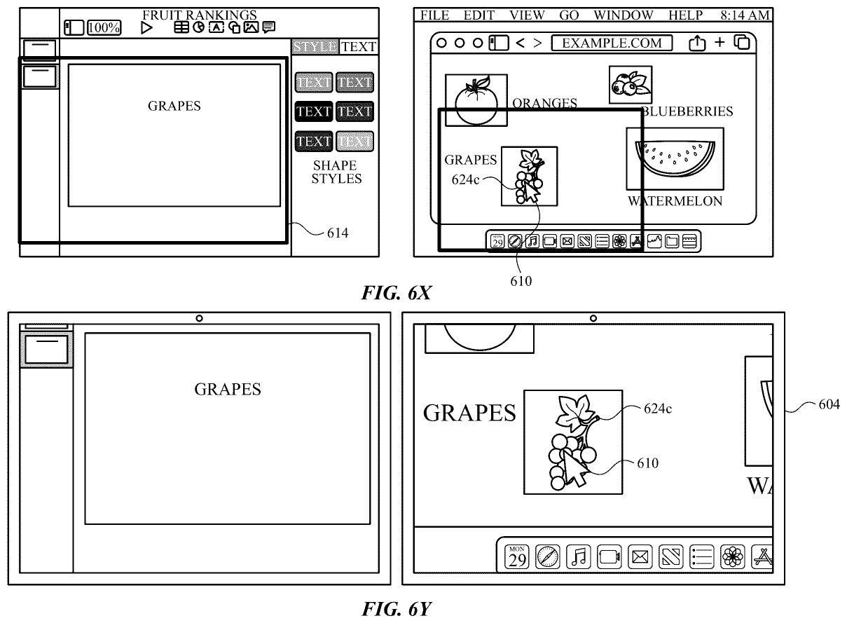

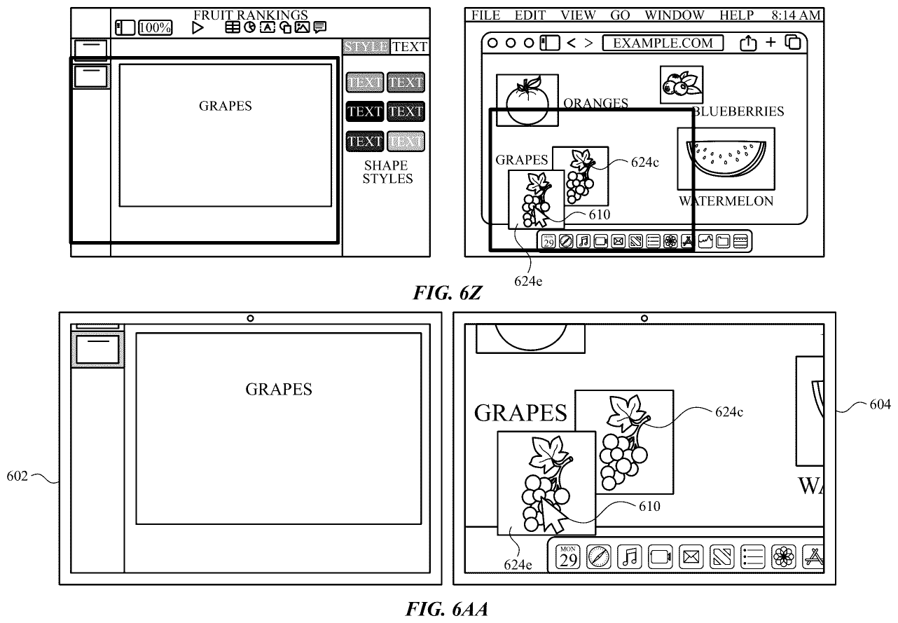

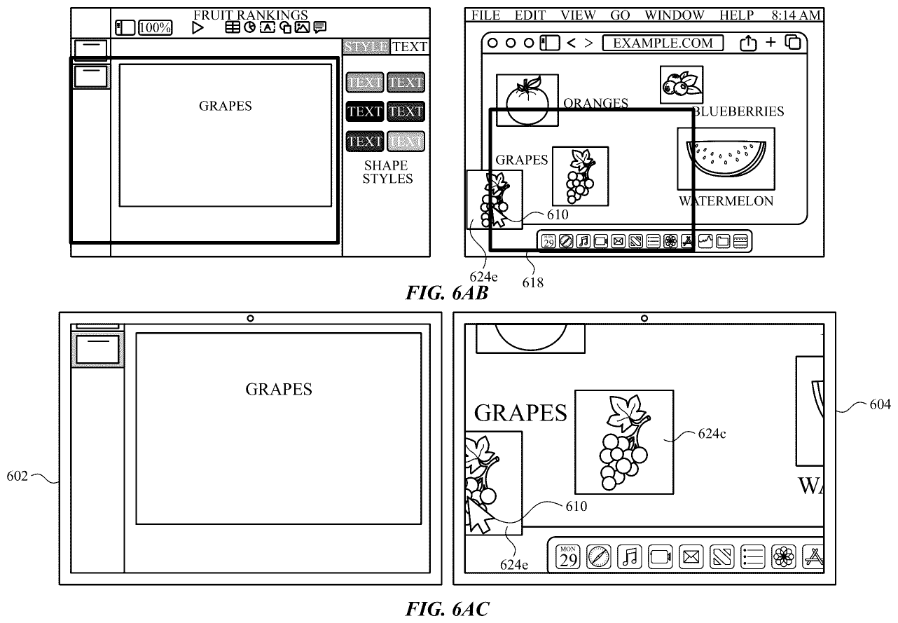

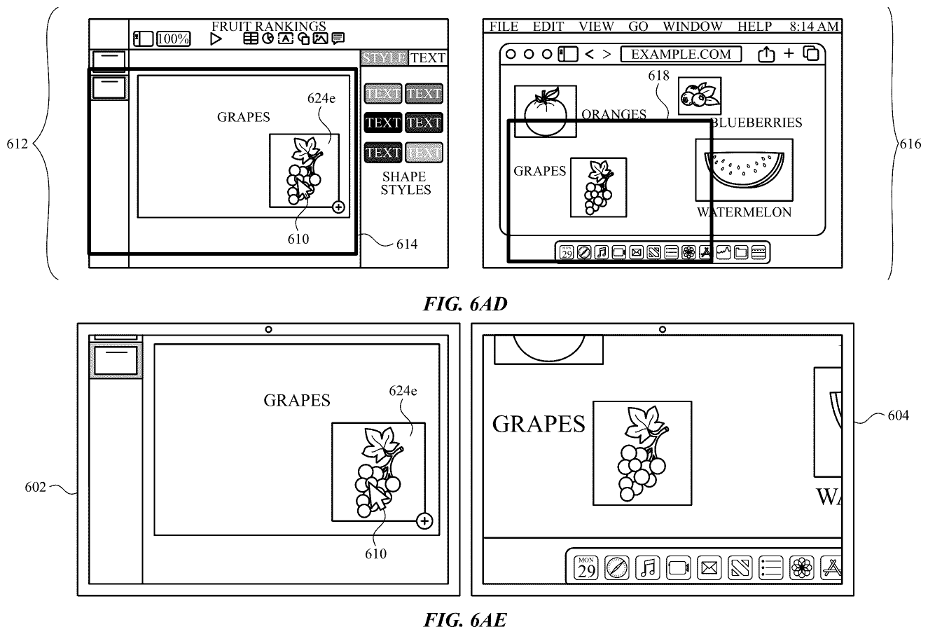

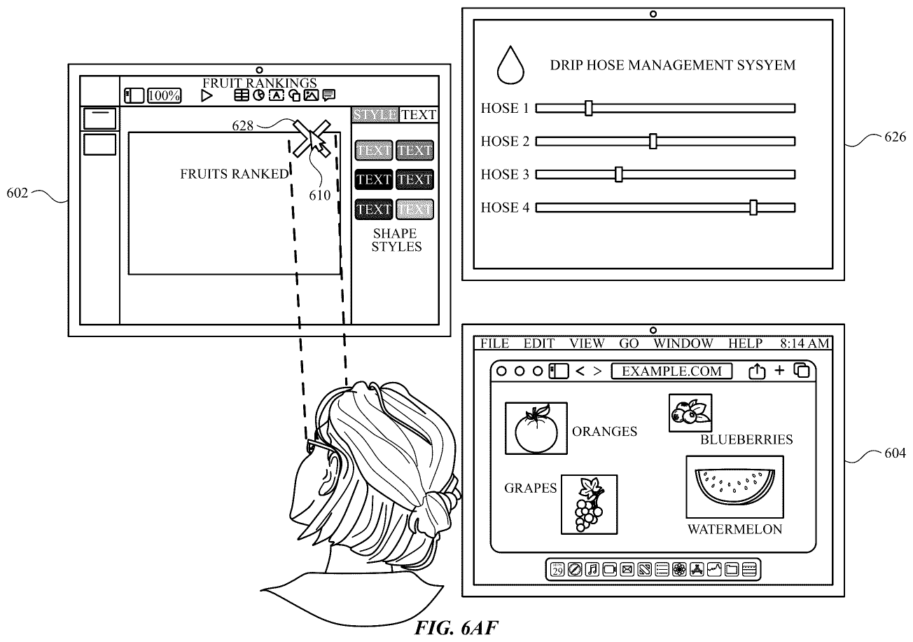

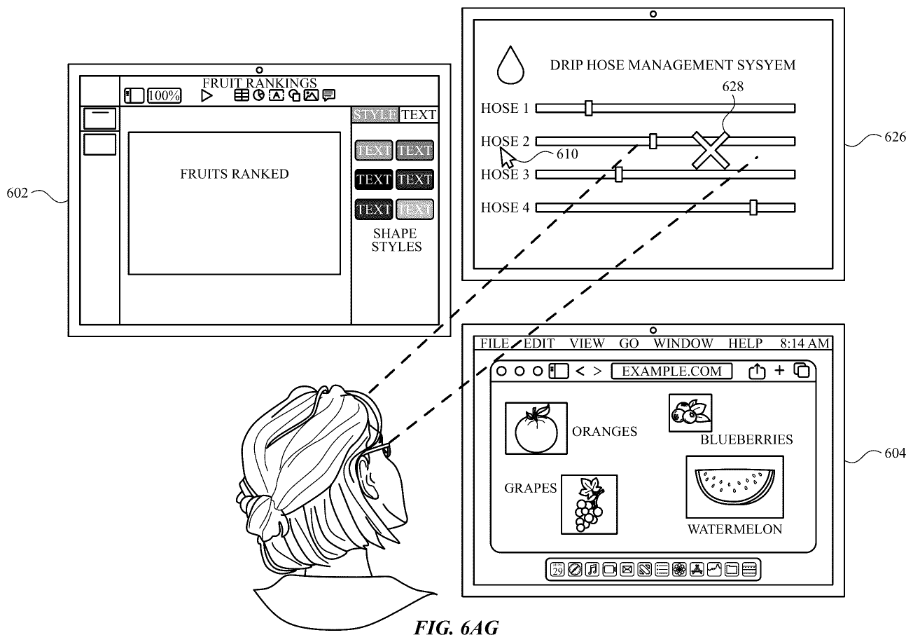

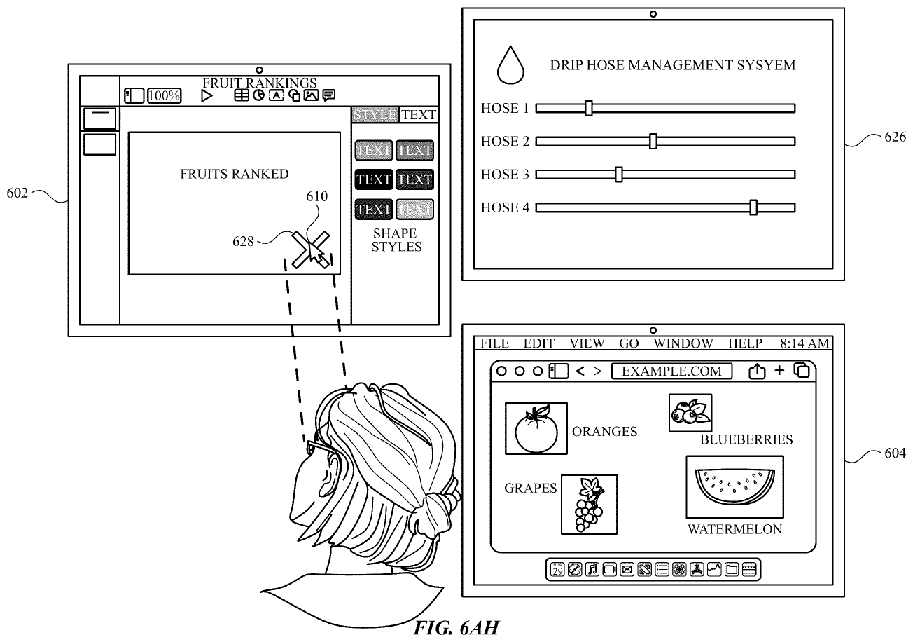

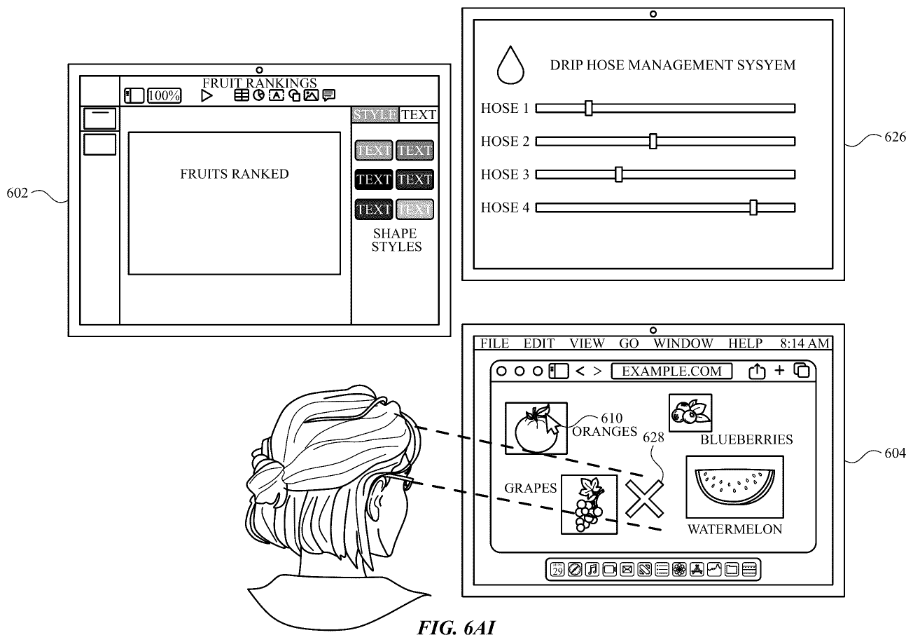

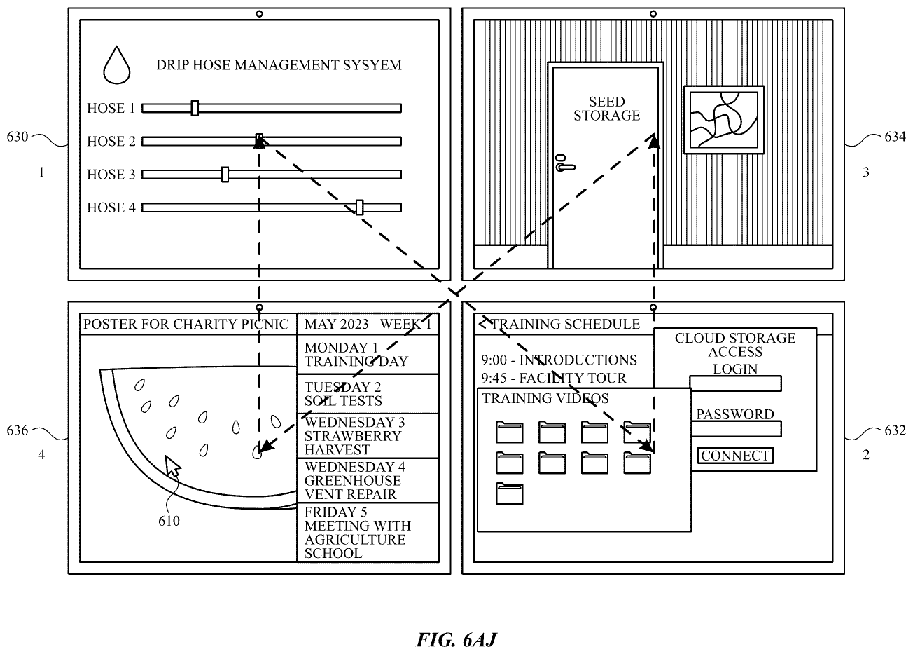

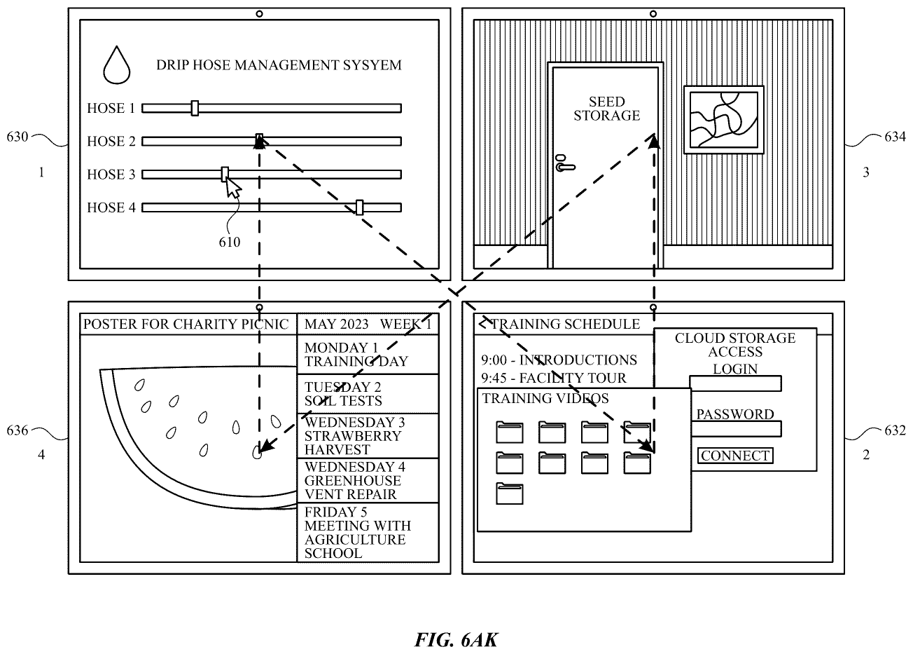

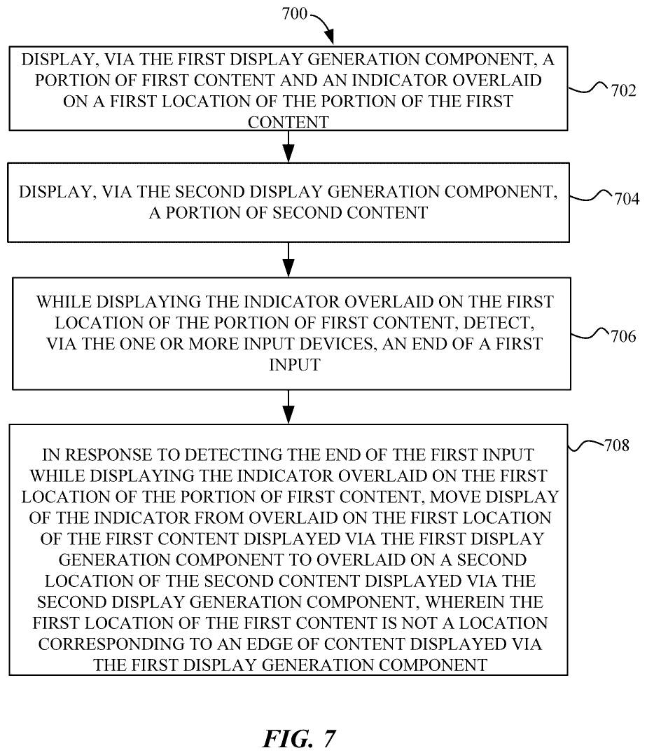

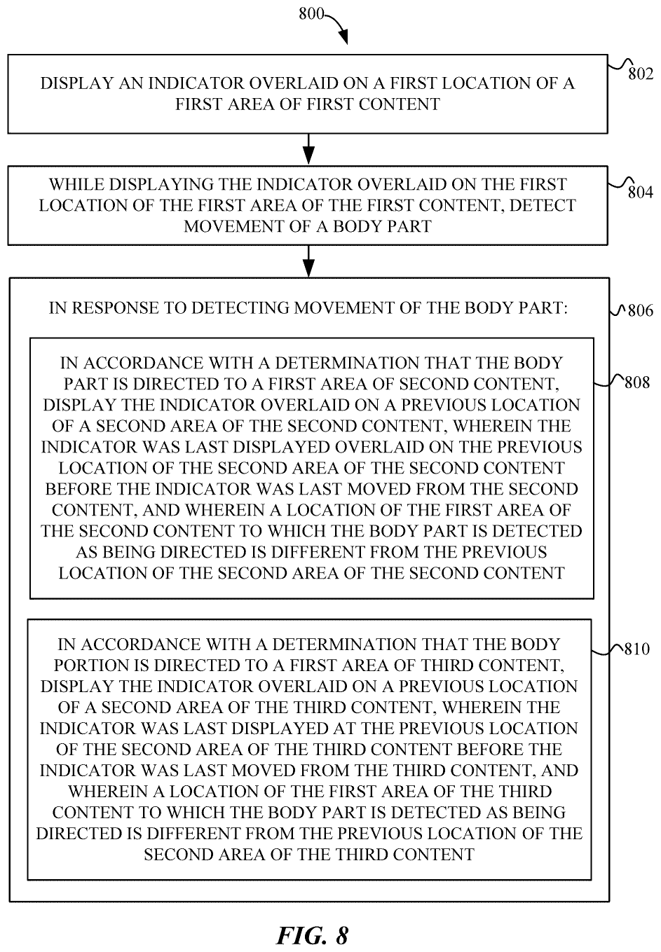

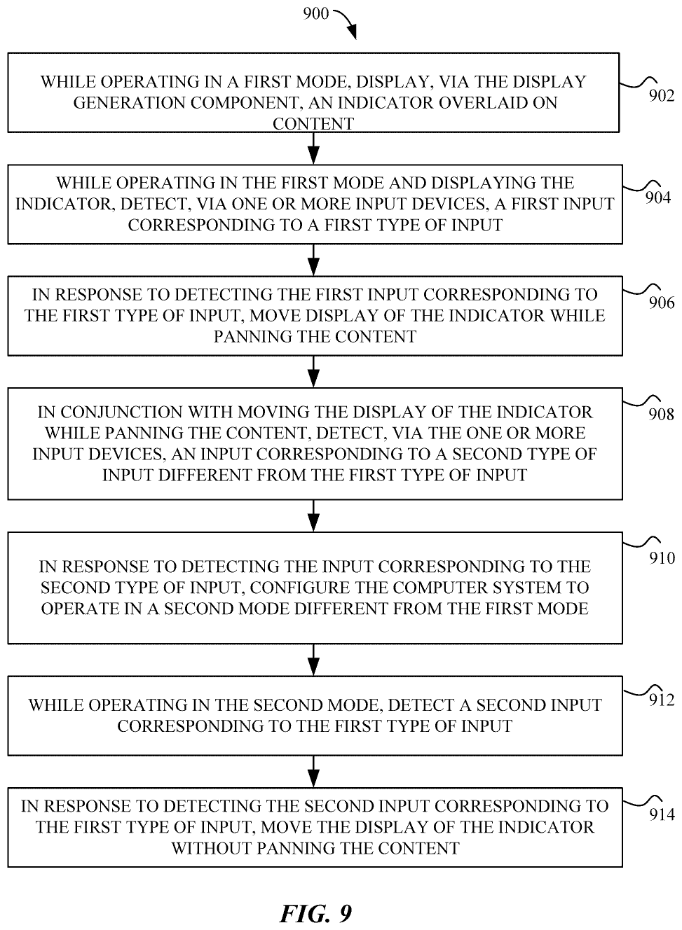

Below, FIGS. 1A-1B, 2, 3, 4A-4B, and 5A-5B provide a description of exemplary devices for performing the techniques for managing one or more displays. FIGS. 6A-6AK illustrate exemplary user interfaces for managing one or more displays in accordance with some examples. FIG. 7 is a flow diagram illustrating a method for moving an indicator between displays in accordance with some examples. FIG. 8 is a flow diagram illustrating a method for moving an indicator based on body movement in accordance with some examples. FIG. 9 is a flow diagram illustrating a method for managing display operations in accordance with some examples. The user interfaces in FIGS. 6A-6AK are used to illustrate the processes described below, including the processes in FIGS. 7-9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc., to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including, but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

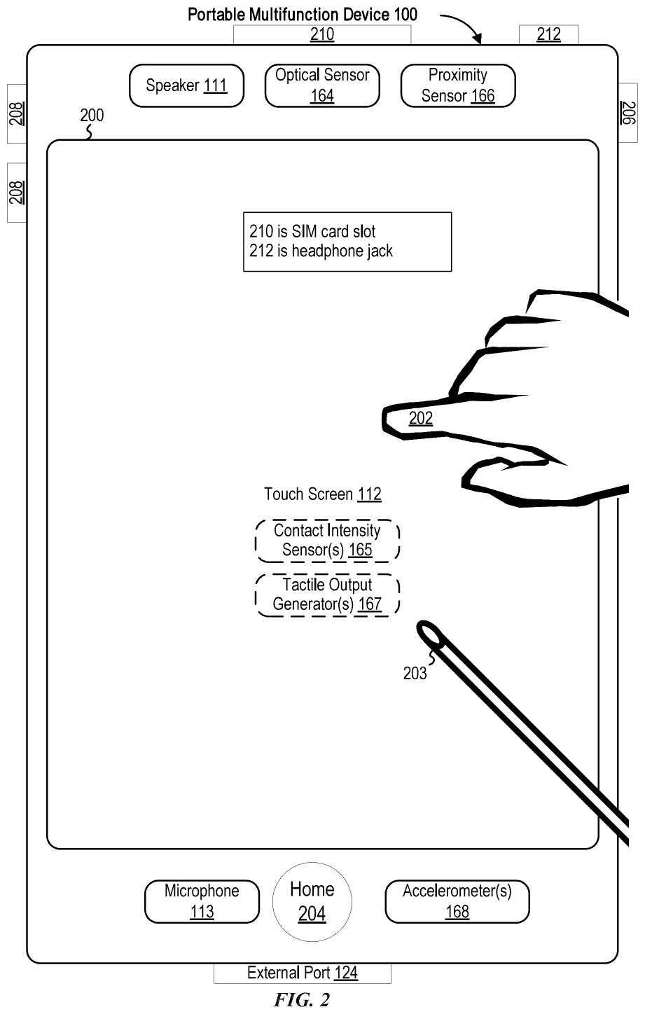

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three-dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

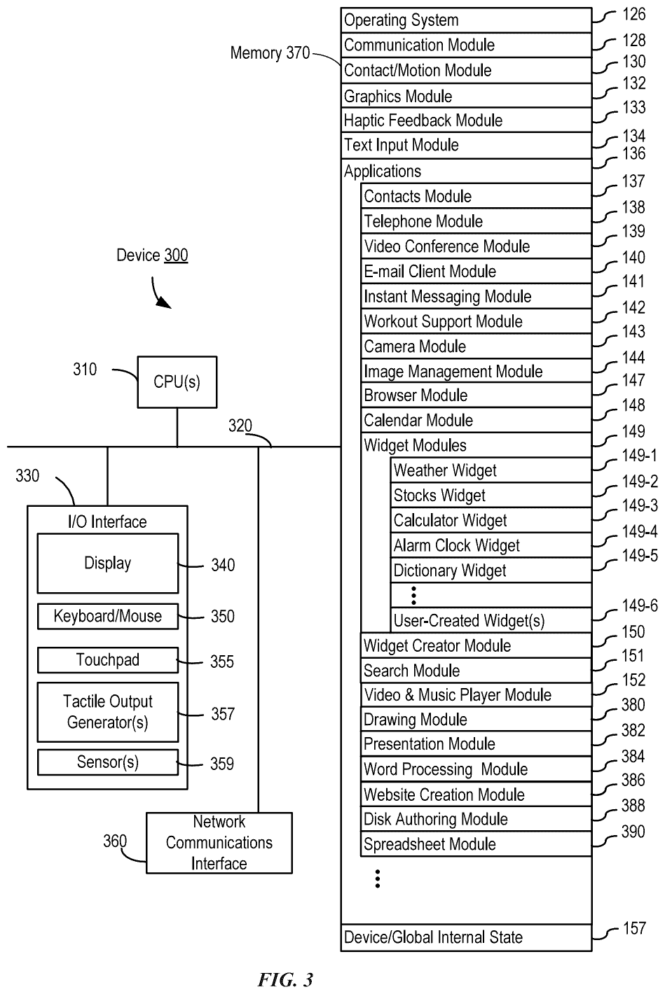

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds is determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (arc) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher-level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event-to-event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137 or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

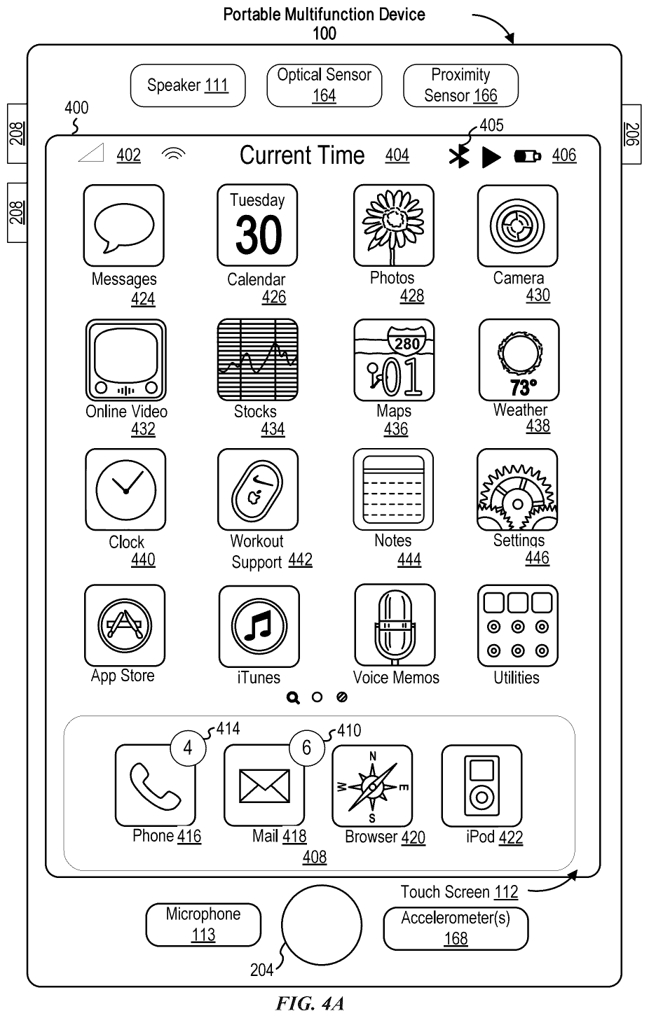

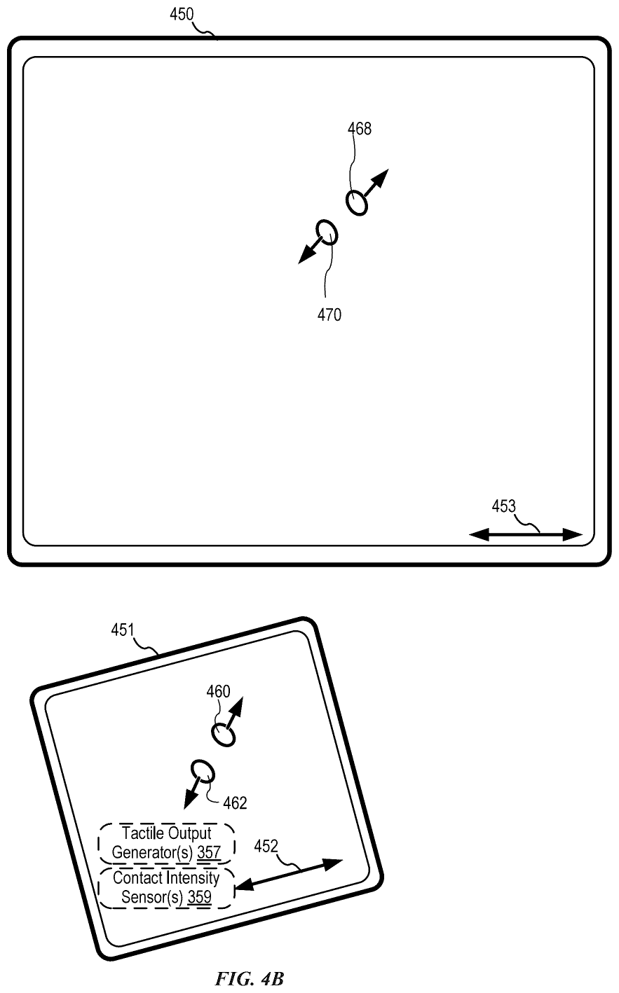

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

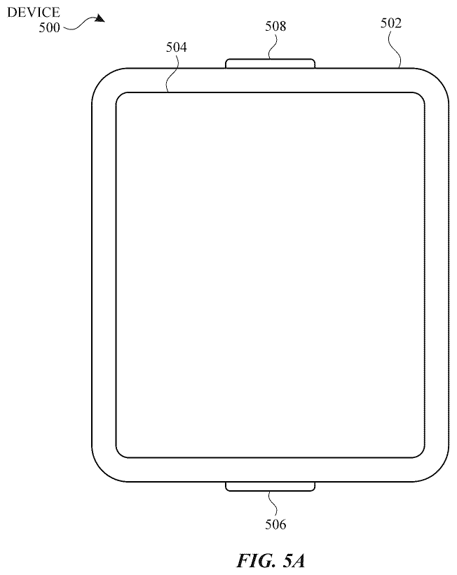

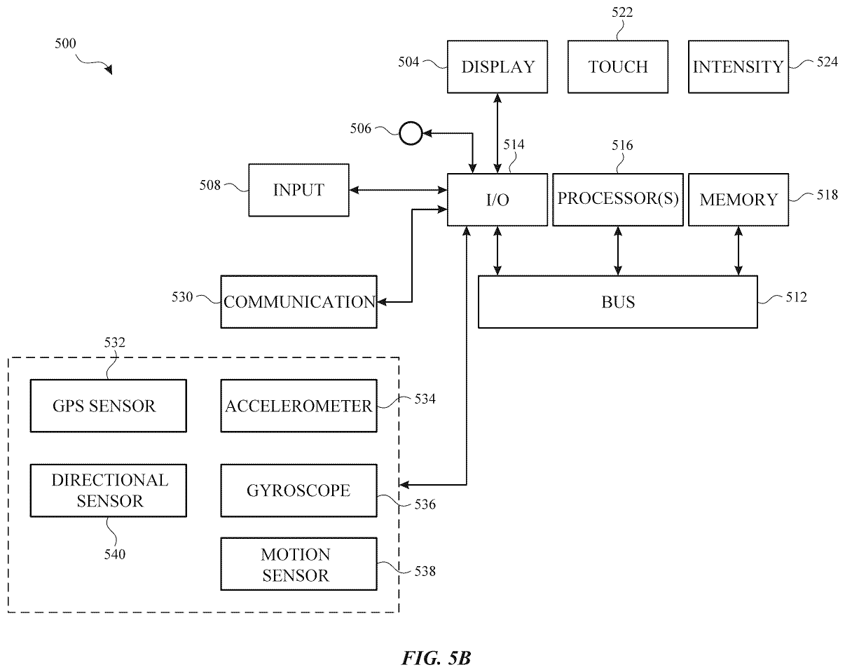

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 800, and 900 (FIGS. 7-9). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press and/or touch input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6AK illustrate exemplary user interfaces for managing one or more displays using a computer system in accordance with some examples. The user interfaces in these figures are used to illustrate the processes described below, including the processes in FIG. 7.

FIG. 6A illustrates computer system 600 connected to left screen 602 and right screen 604. In FIG. 6A, left screen 602 and right screen 604 are separate from computer system 600 (e.g., hereinafter referred to as “the computer system”) and are physical displays. Moreover, as illustrated in FIG. 6A, the computer system does not have a display and/or screen. In some examples, one or more of left screen 602 and right screen 604 are integrated into the computer system. In some examples, the computer system is a smartphone, desktop computer, personal computer, laptop, fitness tracking device (e.g., smartwatch and/or pedometer), head-mounted display device, and/or smart glasses. In some examples, the computer system displays a virtual environment that includes virtual screens (and/or displays) that display content (e.g., similar to the content displayed via left screen 602 and right screen 604). In some examples, one or more techniques described below in relation to managing the physical displays (e.g., screens and/or another type of display) of left screen 602 and right screen 604 can also be used and/or applied to managing one or more virtual displays and/or a combination of physical and/or virtual displays. In some examples, the computer system includes one or more components and/or features described above in relation to electronic devices 100, 300, and/or 500. In some examples, a screen is a display and/or a display generation component (e.g., a projector, a touch-sensitive display, and/or a display area).

FIG. 6A also illustrates keyboard 606 (hereinafter referred to as “the keyboard”) and mouse 608 (hereinafter referred to as “the mouse”), which are connected to the computer system. The keyboard and mouse are two input mechanisms that the computer system is enabled to use to detect and/or receive inputs. As illustrated in FIG. 6A, the computer system is displaying cursor 610 via left screen 602. In some examples, in response to detecting one or more inputs that are directed to the mouse and/or keyboard, the computer system performs one or more operations, such as moving cursor 610. In some examples, the computer system is in communication with one or more cameras. In some examples, the computer system captures one or more images in the field of view of the one or more cameras. In some examples, after capturing the one or more images, the computer system detects various types of gestures/inputs (e.g., air inputs/gestures, gaze inputs, hand input/gestures, head movement input/gestures, and/or movement of one or more portions and/or body parts of a user). In some examples, in response to detecting one or more of the various types of gestures/inputs, the computer system performs one or more operations, such as moving cursor 610 as well as one or more of the operations described below in relation to FIGS. 6B-6AK.

Before discussing FIGS. 6B-6AE, it should understood that the top portion of each page of figures (e.g., FIGS. 6B, 6D, 6F, 6H, 6J, 6L, 6N, 6P, 6R, 6T, 6V, 6X, 6Z, 6AB, 6AD) are schematics illustrating content assigned to each screen and what portion of the content is displayed, and the bottom portion of each page of figures (e.g., FIGS. 6C, 6E, 6G, 6I, 6K, 6M, 6O, 6Q, 6S, 6U, 6W, 6Y, 6AA, 6AC, and 6AE) illustrate what computer system 600 displays via each screen, as further discussed in detailed below. In some examples, the computer system is connected to one or more additional display screens than left screen 602 and right screen 604. In some examples, the computer system is connected to less screens and/or includes a display screen.

As indicated in FIG. 6B and illustrated in FIG. 6C, left screen full content 612 is displayed via left screen 602. FIG. 6B also illustrates left screen boundary 614, which indicates what portion of left screen full content 612 that the computer system is displaying via left screen 602 of FIG. 6C. In FIG. 6B, left screen boundary 614 surrounds the entirety of left screen full content 612, which indicates that left screen 602 of FIG. 6C is displaying the entirety of left screen full content 612 of FIG. 6B. Likewise, FIG. 6B illustrates right screen full content 616, which is displayed via right screen 604 of FIG. 6C. Right screen boundary 618 is illustrated to indicate what portion of right screen full content 616 that the computer system is displaying via right screen 604 of FIG. 6C. Like left screen boundary 614, in FIG. 6B, right screen boundary 618 surrounds the entirety of right screen full content 616, which indicates that right screen 604 of FIG. 6C is displaying the entirety of content corresponding to right screen full content 616 of FIG. 6B. In other words, at FIGS. 6B-6C, left screen boundary 614 represents the edge of what is visible on left screen 602, and right screen boundary 618 represents the edge of what is visible on right screen 604. At FIGS. 6B-6C, left screen 602 and right screen 604 are at the same zoom level. In some examples, the computer system displays left screen full content 612 of FIG. 6B while left screen 602 is completely zoomed out and/or zoomed out to a minimum level (and/or maximum level) defined by one or more settings and/or modes. In some examples, the computer system displays right screen full content 616 of FIG. 6B while right screen 604 of FIG. 6C is completely zoomed out and/or zoomed out to a minimum zoom level (and/or maximum zoom level) defined by one or more settings and/or modes.

At FIG. 6B, left screen full content 612 and right screen full content 616 are different content. As illustrated in FIGS. 6B-6C, the computer system displays slide presentation user interface 620 as occupying the entire of area of left screen 602 and desktop user interface 622 as occupying the entire area of right screen 604. Slide presentation user interface 620 includes selected slide 620a, first slide 620b, and second slide 620c, where the computer system displays selected slide 620a near the center of slide presentation user interface 620. On the other hand, desktop user interface 622 includes browser user interface 624, which is overlaid on a portion of desktop user interface 622. As illustrated in FIGS. 6B-6C, browser user interface 624 includes menu 654a and navigation bar 654b. As illustrated in FIGS. 6B-6C, browser user interface 624 includes first image 624a, second image 624b, third image 624c, and fourth image 624d arranged in a grid. In FIGS. 6B-6C, the computer system displays cursor 610 at a location on left screen 602 and does not display a representation of cursor 610 in right screen 604. As illustrated in FIGS. 6B-6C, the location of cursor 610 is in the middle of and not at near and/or adjacent to the edge of content displayed via left screen 602. At FIGS. 6B-6C, the computer system detects one or more inputs. In some examples, detecting the one or more inputs includes detecting keyboard input corresponding to a set of hotkeys being pressed (and/or de-pressed). In some examples, the set of hotkeys is edited and/or configurated to cause the computer system to perform the one or more operations described in relation to FIGS. 6D-6E. In some examples, the set of hotkeys is editable and/or configurable by a user to cause the computer system to perform one or more particular operations. In some examples, the keyboard input occurs while an input directed to the mouse is causing the computer system to change the zoom or pan of a screen and/or to move cursor 610 to different locations on the screen. In some examples, detecting the one or more inputs includes detecting an input via the keyboard, the mouse, a touchpad, a touch-sensitive display, a voice command, a head movement, an air input/gesture, and/or a gaze of a user.

As illustrated in FIGS. 6D-6E, in response to detecting the one or more inputs at FIGS. 6B-6C, the computer system displays left screen 602 at a new zoom level (and/or changes the zoom level of left screen 602). As illustrated in FIGS. 6D-6E, the computer system does not display right screen 604 at a new zoom level in response to detecting the one or more inputs at FIGS. 6B-6C. In some examples, the one or more inputs at FIGS. 6B-6C cause the computer system to no longer allow movement of cursor 610 over content of left screen 602 without concurrent movement of content of left screen 602 unless a boundary of content assigned to left screen 602 is reached (e.g., as illustrated by the schematic of FIG. 6D where (1) movement up and/or to the left would cause the computer system to move cursor 610 without moving content displayed by left screen 602 and (2) movement down and/or to the right would cause the computer system to move cursor 610 concurrently with content displayed by left screen 602 until a right and/or bottom boundary of content assigned to left screen 602 is reached.

FIG. 6E illustrates the computer system causing left screen 602 and right screen 604 to display their respective content in view of the changing the zoom level of left screen 602 and not changing the zoom level of right screen 604 (e.g., in response to detecting the one or more inputs at FIGS. 6B-6C). As illustrated in FIG. 6E, the computer system has zoomed left screen 602, such that content displayed via left screen 602 has gotten bigger. This is due to the portion of left screen full content 612 inside of left screen boundary 614 of FIG. 6D being stretched across left screen 602 of FIG. 6E. Thus, as illustrated in FIG. 6E, the computer system displays an upper left portion of left screen full content 612 of FIG. 6D on left screen 602, which causes portion of left screen full content 612 to appear bigger and/or zoomed in on left screen 602. Moreover, the computer system displays cursor 610 of FIG. 6E as being larger than cursor 610 of FIG. 6C because the zoom level of left screen 602 has increased. At FIGS. 6D-6E, the computer system detects one or more inputs corresponding to movement of cursor 610. In some examples, the computer system changes the zoom level of left screen 602 because the computer system was displaying cursor 610 via left screen 602 while the computer system detected the one or more inputs at FIGS. 6B-6C. In some examples, the computer system does not change the zoom level of right screen 604 because the computer system was not displaying cursor 610 via right screen 604 while the computer system detected the one or more inputs at FIGS. 6B-6C. In some examples, the computer system zooms left screen 602 to a location that is based on the location of cursor 610. In some examples, the computer system zooms left screen 602 to a location that is not based on the location of cursor 610. In some examples, the computer system changes the zoom level of the left screen and/or a zoom level that is programmatically associated with the left screen (e.g., via one or more settings). In some examples, changing the zoom level does not include changing the minimum zoom level (and/or maximum zoom level) defined by one or more settings and/or modes.

In some examples, detecting the one or more inputs includes detecting an input via a keyboard, the mouse, a touchpad, a touch-sensitive display, a voice command, a head movement, an air input/gesture, and/or a gaze of a user.

As illustrated in FIGS. 6F-6G, in response to the one or more inputs corresponding to movement of cursor 610, the computer system moves cursor 610 downward and pans the content displayed via left screen 602. FIG. 6F illustrates the panning by left screen boundary 614 being moved down. Notably, at FIG. 6G, the computer system does not increase the size and/or zoom level of left screen 602 in response to detecting the one or more inputs at FIGS. 6D-6E. As illustrated in FIGS. 6F-6G, the computer system moves cursor 610 and left screen boundary 614 in the same direction; however, the computer system continues to display cursor 610 via left screen 602 at FIGS. 6F-6G. As illustrated in FIGS. 6F-6G, the computer system is not displaying cursor 610 at a location near and/or adjacent to an edge of content displayed via left screen 602. Moreover, in response to the one or more inputs corresponding to movement of cursor 610, the computer system does not pan content displayed via right screen 604. In addition, FIG. 6G illustrates that content displayed via right screen 604 did not change. As illustrated in FIGS. 6F-6G, the computer system displays cursor 610 inside of left screen boundary 614, and there are no changes to right screen full content 616 or right screen boundary 618. In some examples, the computer system does not pan content displayed via right screen 604 because cursor 610 was not displayed via right screen 604 while the one or more inputs corresponding to movement of cursor 610 was detected at FIGS. 6D-6E. At FIGS. 6F-6G, the computer system detects one or more inputs corresponding to a request to move cursor 610 from left screen 602 to right screen 604. In some examples, detecting the one or more inputs includes detecting an input via a keyboard, the mouse, a touchpad, a touch-sensitive display, a voice command, a head movement, an air input/gesture, and/or a gaze of a user. In some examples, the one or more inputs corresponding to the request to move cursor 610 from left screen 602 to right screen 604 does not correspond to a dragging input, a swiping input, and/or movement of the mouse from a location corresponding to left screen 602 to a location corresponding to right screen 604. In some examples, the one or more inputs corresponding to the request to move cursor 610 from left screen 602 to right screen 604 include pressing one or more option, command, and/or other keys simultaneously, concurrently, and/or within a predetermined period of time of each other. In some examples, the one or more inputs corresponding to the request to move cursor 610 from left screen 602 to right screen 604 is an alternative way to move cursor 610 to right screen 604. In such examples, cursor 610 can be moved to right screen 604 by the computer system detecting cursor 610 being moved from left screen 602 to right screen 604 via a dragging input, a swiping input, and/or movement of the mouse, requiring a user to need to move cursor 610 across content of left screen 604 before cursor 610 is displayed at an edge of right screen 604.

As illustrated in FIGS. 6H-6I, in response to detecting the one or more inputs corresponding to the request to move cursor 610 from left screen 602 to right screen 604, the computer system jumps cursor 610 to a location on right screen 604 that corresponds to a location previously occupied by cursor 610. In some examples, to jump cursor 610, the computer system does not display cursor 610 near an edge of content displayed via left screen 602 and/or an edge of content displayed via right screen 604 before cursor 610 is displayed in the location on right screen 604 at FIGS. 6H-6I. In some examples, to jump cursor 610, the computer system does not display cursor 610 at any other locations on left screen 602 after detecting the one or more inputs corresponding to the request to move cursor 610 from left screen 602 to right screen 604. In some examples, to jump cursor 610, the computer system does not display cursor 610 at any other locations on right screen 604 before cursor 610 is displayed at the location of cursor 610 in FIGS. 6H-6I (e.g., after detecting the one or more inputs corresponding to the request to move cursor 610 from left screen 602 to right screen 604). In some examples, the computer system displays an indication that cursor 610 is being (or has been) moved (e.g., in addition to changing the position of the cursor) by emphasizing cursor 610, such as displaying cursor 610 being resized, cursor 610 glowing, and/or cursor 610 being highlighted. In some examples, the computer system displays the indication that cursor 610 is being moved in response to detecting a first type of inputs (e.g., a set of hotkeys) and does not display the indication that cursor 610 is being moved in response to a second type of inputs (e.g., such as movement of the cursor and/or movement of a body part of a user) that are different from the first type of inputs. In some examples, the first type of inputs are non-directional inputs, such as a set of hotkeys and/or a voice command while the second type of inputs are directional inputs (e.g., a swipe in a different and/or movement of the body in a direction). In some examples, in response to detecting the second type of input, cursor 610 is jumped in a direction that is based on the direction of the second type of input. In some examples, in response to detecting the first type of input, cursor 610 is jumped but is not jumped in a direction that is based on a direction of the first type of input.

As illustrated in FIGS. 6H-6I, in response to detecting the one or more inputs corresponding to the request to move cursor 610 from left screen 602 to right screen 604, the computer system causes the size of cursor 610 to change because of the difference in the current zoom levels between left screen 602 and right screen 604. Here, the computer system displays cursor 610 as being smaller because right screen 604 has a lower zoom level than left screen 602 at FIGS. 6H-6I. At FIGS. 6H-6I, the computer system detects one or more inputs (e.g., using one or more similar techniques discussed above in relation to detecting one or more inputs at FIGS. 6B-6C).

As illustrated in FIGS. 6J-6K, in response to detecting the one or more inputs, the computer system zooms right screen 604, which causes right screen full content 616 to zoom and/or content displayed via right screen 604 to be displayed at an increased zoom level (e.g., compared to content in right screen 604 of FIG. 6I). FIG. 6J illustrates that right screen full content 616 is zoomed because right screen boundary 618 has decreased in size to represent what is visible on right screen 604 of FIG. 6K. At FIGS. 6J-6K, the computer system increases the size of cursor 610 because the zoom level of right screen 604 has been increased. When comparing FIG. 6I to FIG. 6K, the computer system ceases displaying menu 654a because the computer system has zoomed right screen 604 and has not only zoomed certain content displayed via right screen 604 (e.g., such as the browser application). At FIG. 6K, navigation bar 654b continues to be displayed. Looking at FIG. 6J, the right screen boundary 618 is located along the bottom center edge of right screen full content 616 and frames a portion of the right screen full content 616, which is displayed on right screen 604 of FIG. 6K. Notably, at FIGS. 6J-6K, the computer system does not change the zoom level of left screen 602 (e.g., using one or more techniques discussed above in relation to not changing the zoom level of right screen 604 at FIGS. 6B-6E). At FIGS. 6J-6K, the computer system detects one or more inputs (e.g., using similar techniques as discussed above in relation to FIGS. 6B-6C).

As illustrated in FIGS. 6L-6M, in response to detecting the one or more inputs at FIGS. 6J-6K, the computer system zooms right screen 604 and does not zoom left screen 602 (and/or continues to have left screen 602 maintain the same zoom level) (e.g., using one or more similar techniques as described above in relation to FIGS. 6J-6K). In some examples, in response to detecting one or more inputs that are opposite of at least one of the one or more inputs detected at FIGS. 6J-6K (e.g., an upward scroll input via the mouse as compared to a downward scroll input via the mouse, a pinch input as compared to a de-pinch input, and/or a tilt head forward input as compared to a tilt head backward input), the computer system zooms right screen 604 out (instead of in). At FIGS. 6L-6M, the computer system detects one or more inputs corresponding to a request to move cursor 610 from right screen 604 to left screen 602. In some examples, the one or more inputs corresponding to a request to move cursor 610 from right screen 604 to left screen 602 is the same type of input as the one or more inputs corresponding to a request to move cursor 610 from left screen 602 to right screen 604 (e.g., discussed above in relation to FIGS. 6F-6I). In some examples, the one or more inputs corresponding to a request to move cursor 610 from right screen 604 to left screen 602 is a different type of input than the one or more inputs corresponding to a request to move cursor 610 from left screen 602 to right screen 604. In some examples, both of these one or more inputs are a set of hotkeys inputs, and/or the computer system detects the one or more inputs based on detecting a particular set of hotkeys being press and/or de-pressed on a keyboard. In some examples, one of the one or more inputs are an input in a first direction (e.g., a head movement from right to left, up to down, side to side, etc.) and the other of the one or more inputs are an input in a different direction. In some examples, the different direction is an opposite direction of the first direction (e.g., northwest as compared to southeast, north as compared to south and/or west as compared to cast).

As illustrated in FIGS. 6N-6O, in response to detecting the one or more inputs corresponding to a request to move cursor 610 from right screen 604 to left screen 602, the computer system jumps cursor 610 from a location on right screen 604 to the location at which cursor 610 was displayed previously on left screen 602 (e.g., at FIG. 6G). In other words, the location of cursor 610 at FIGS. 6N-6O is the location at which cursor 610 was displayed before cursor 610 the computer system removed (and/or ceased to display) cursor 610 from left screen 602 (e.g., in response to detecting the one or more inputs corresponding to a request to move cursor 610 from left screen 602 to right screen 604, discussed above in relation to FIGS. 6F-6I). In some examples, the computer system uses one or more techniques described above in relation to FIGS. 6F-6I and jumping cursor 610 between screens. At FIGS. 6N-6O, the computer system detects one or more inputs (e.g., using one or more techniques described above in relation to FIGS. 6B-6C).

As illustrated in FIGS. 6P-6Q, in response to the one or more inputs at FIGS. 6N-6O, the computer system moves cursor 610, such that cursor 610 is displayed at a location over second slide 620c. At FIGS. 6P-6Q, the computer system detects one or more inputs corresponding to selection of second slide 620c. In some examples, detecting the one or more inputs corresponding to selection of second slide 620c includes detecting one or more inputs via the keyboard, the mouse, a touchpad, a touch-sensitive display, a voice command, a head movement, an air input/gesture, and/or a gaze of a user.

As illustrated in FIGS. 6R-6S, in response to one or more inputs corresponding to selection of second slide 620c, the computer system displays second slide 620c as being selected while maintaining the zoom level of left screen 602. At FIGS. 6R-6S, in response to one or more inputs corresponding to selection of second slide 620c, the computer system does not adjust the zoom level of left screen 602 and right screen 604, and the computer system does not pan the zoom level of left screen 602 and right screen 604. At FIGS. 6R-6S, the computer system detects an input corresponding to a request to move cursor 610 from left screen 602 to right screen 604 (e.g., using one or more techniques described above in relation to FIGS. 6F-6I).

As illustrated in FIGS. 6T-6U, in response to detecting input corresponding to a request to move cursor 610 from left screen 602 to right screen 604, the computer system displays cursor 610 at a location on right screen 604, where cursor 610 was previously displayed before, and cursor 610 was removed from left screen 602 (e.g., location of cursor 610 in FIGS. 6L-6M). At FIGS. 6T-6U, the computer system detects one or more inputs corresponding to movement of cursor 610.

As illustrated in FIGS. 6V-6W, in response to the one or more inputs corresponding to movement of cursor 610, the computer system moves cursor 610 to the left as well as pans the content displayed via right screen 604 to the left. FIG. 6V illustrates the panning by right screen boundary 618 being moved left. Notably, at FIGS. 6V-6W, the computer system does not increase the size and/or zoom level of right screen 604 in response to detecting one or more inputs at FIGS. 6T-6U. As illustrated in FIGS. 6V-6W, the computer system moves cursor 610 and right screen boundary 618 in the same direction; however, the computer system continues to display cursor 610 via right screen 604 at FIGS. 6V-6W. As illustrated in FIGS. 6V-6W, the computer system is not displaying cursor 610 at a location near and/or adjacent to an edge of content displayed via right screen 604. Moreover, in response to the one or more inputs corresponding to movement of cursor 610, the computer system does not pan content displayed via left screen 602. In addition, FIG. 6W illustrates that content displayed via left screen 602 did not change. As illustrated in FIGS. 6V-6W, the computer system displays cursor 610 inside of right screen boundary 618, and there are no changes to left screen full content 612 or left screen boundary 614. In some examples, the computer system does not pan content displayed via right screen 604 because cursor 610 was not displayed via right screen 604 while one or more inputs corresponding to movement of cursor 610 was detected at FIGS. 6T-6U. At FIGS. 6V-6W, the computer system detects one or more inputs corresponding to movement of cursor 610 (e.g., as described above in relation to FIGS. 6T-6U).

As illustrated in FIGS. 6X-6Y, in response to detecting the one or more inputs corresponding to the request to move cursor 610, the computer system moves cursor 610 on right screen 604, such that cursor 610 is displayed at a location over third image 624c that is in browser user interface 624. At FIGS. 6X-6Y, the computer system detects one or more inputs corresponding to selection of third image 624c (e.g., using one or more similar techniques discussed above in relation to detecting one or more inputs at FIGS. 6P-6Q). At FIGS. 6X-6Y, the computer system detects one or more inputs (e.g., using one or more similar techniques discussed above in relation to detecting one or more inputs at FIGS. 6B-6C).

As illustrated in FIGS. 6Z-6AA, in response to detecting one or more inputs, the computer system displays image representation 624c. As illustrated in FIGS. 6Z-6AA, in response to detecting one or more inputs, the computer system moves cursor 610 and image representation 624e to the left. Image representation 624e is a visualization of a file copy of third image 624c. At FIGS. 6Z-6AA, in response to detection one or more inputs the computer system does not adjust the zoom level of left screen 602 and right screen 604, and the computer system does not pan the zoom level of left screen 602 and right screen 604. At FIGS. 6Z-6AA, the computer system detects one or more inputs (e.g., using one of more techniques described above in relation to FIGS. 6B-6C).

As illustrated in FIGS. 6AB-6AC, in response to the one or more inputs, the computer system moves cursor 610 and image representation 624e to the left on right screen 604. As illustrated in FIG. 6AB, the computer system is displaying cursor 610 at the left edge of right screen boundary 618. As illustrated in FIG. 6AB, image representation 624c is crossing right screen boundary 618; however, the computer system only displays a portion (e.g., portion inside of right screen boundary 618 of FIG. 6AB) of image representation 624e because the computer system has zoomed right screen 604 of FIG. 6AC. Notably, at FIG. 6AC, the computer system is not displaying any portion of image representation 624e via left screen 602 while image representation 624e is at the edge of the content displayed via right screen 604. In some examples, this effect is generated because particular content is assigned to a particular screen and image representation 624e has not reached the content displayed on left screen 604 at FIG. 6AC. At FIGS. 6AB-6AC, the computer system continues to detect movement of the one or more inputs detected in FIGS. 6Z-6AA.

As illustrated in FIGS. 6AD-6AE, in response to detecting movement of the one or more inputs, the computer system moves image representation 624c to a location on left screen 602, where the entirety of image representation 624e is inside of left screen boundary 614. As illustrated in FIGS. 6AD-6AE, the computer system displays image representation 624e at a size that is based on the zoom level of left screen 602. Moreover, the computer system changes image representation 624e to include one or more characteristics (e.g., “plus-sign user interface object”) that are associated with the left screen full content 612 and/or the application displayed via left screen 602 (e.g., that cursor 610 and image representation 624e overlaid on at FIG. 6AE). In some examples, the computer system does not display a portion of representation 624e via left screen 602 until the portion of image representation 624e is inside of left screen boundary 614. In some examples, the computer system does not display any of image representation 624e via any screens (e.g., left screen 602 and right screen 604) while image representation 624c is not inside of left screen boundary 614 or right screen boundary 618, irrespective of whether the location of image representation 624e is at a location corresponding a location outside of left screen boundary 614 (and, in some examples, inside of left screen full content 612) and/or right screen boundary 618 (and, in some examples, inside of right screen full content 616).

FIGS. 6AF-6AG illustrate user interfaces for jumping a cursor from one screen to another screen using body position tracking. FIG. 6AF illustrates the computer system in communication with three screens, including left screen 602, right screen 604, and upper screen 626. As illustrated in FIG. 6AF, right screen 604 is positioned down and to the right in space relative to left screen 602, and upper screen 626 is positioned up and to the right in space relative to left screen 602. Moreover, upper screen 626 is located above right screen 604. As illustrated in FIG. 6AF, the user is positioned in a way that user gaze 628 detected at a location on left screen 602. As illustrated in FIG. 6AF, the computer system is displaying cursor 610 in the same location as user gaze 628. At FIG. 6AF, the computer system detects a change in the position of the user (and/or the head of the user) from being positioned toward the left screen 602 to being positioned toward the right of left screen 602.

At FIG. 6AG, in response to detecting the user from being positioned toward the left screen 602 to being positioned toward the right of left screen 602, a determination is made that cursor 610 should be moved to upper screen 626. In some examples, the determination is made because cursor 610 was closer to upper screen 626 than right screen 604 before detecting the change in the body position of the user toward the right of left screen 602. In some examples, this determination is made because the user is positioned toward upper screen 626.

Looking back at FIG. 6AF, the computer system displayed cursor 610 closer to the top of left screen 602 than the bottom of left screen 602, where the top of left screen 602 is closer to upper screen 626 than right screen 604. As illustrated in FIG. 6AG, in response to detecting the user from being positioned toward the left screen 602 to being positioned toward the right of left screen 602, the computer system jumps cursor 610 to upper screen 626. Notably, at FIG. 6AG, user gaze 628 and cursor 610 are not at the same location on upper screen 626. Thus, cursor 610 is not being displayed at a location that corresponds to the location of user gaze 628. In some examples, as a part of detecting the change in the position of the user, the computer system detects a change in the position of the head of the user and/or detects a change in the body position of the user. In some examples, when the user looks in a direction that does not contain a screen, the computer system does not change the location of cursor 610. At FIG. 6AG, the computer system detects a change in the position from being positioned toward upper screen 626 to being positioned toward the left upper screen 626. In some examples, the user of FIG. 6AG is not looking at particular display, is looking at a location (e.g., in empty space and/or a location in the environment that does not include one or more displays) in the above, middle, and/or below right screen 604 and/or 626, and her head is fully turned to the right, and the computer system performs the same operations discussed with respect to FIGS. 6AF-6AG.

FIGS. 6AH-6AI is an alternative scenario than the one described above in relations to FIGS. 6AF-6AG. Unlike in FIGS. 6AF, the computer system is displaying cursor 610 at a position that is closer to right screen 604 than upper screen 626 at FIG. 6AH. As illustrated in FIG. 6AH, the user is positioned in a way that user gaze 628 detected at a location on left screen 602, and the computer system is displaying cursor 610 in the same location as user gaze 628. At FIG. 6AH, the computer system detects a change in the position of the user (and/or the head of the user) from being positioned toward the left screen 602 to being positioned toward the right of left screen 602.

At FIG. 6AH, in response to detecting the user from being positioned toward the left screen 602 to being positioned toward the right of left screen 602, a determination is made that cursor 610 should be moved to right screen 604. In some examples, this determination is made because cursor 610 was closer to right screen 604 than upper screen 626 before detecting the user from being positioned toward the left screen 602 to being positioned toward the right of left screen 602. In some examples, this determination is made because the user is positioned toward right screen 604.

As illustrated in FIG. 6AH, in response to detecting the user from being positioned toward the left screen 602 to being positioned toward the right of left screen 602, the computer system jumps cursor 610 to right screen 604. Notably, at FIG. 6AH, user gaze 628 and cursor 610 are not at the same location on upper screen 626 (e.g., for similar reasons as described above in relation to FIG. 6AG). In some examples, the computer system jumps the cursor to a particular screen based on the area of a display that is associated with another display. In some examples, the top of left screen 602 is associated with upper screen 626 and the bottom half of left screen 602 is associated with right screen 604. In some of these examples, the computer system 600 moves cursor 610 to upper screen 626 when a determination is made that the user has changed to be positioned to the right while cursor 610 is displayed in the top half of left screen 602, the computer system moves cursor 610 to right screen 604 when a determination is made that the user has changed to be positioned to the right while cursor 610 is displayed in the bottom half of left screen 602. In some examples, an area of a particular screen is programmatically associated with a particular screen, where the association of the particular area and a particular screen can change as screens are added and/or removed from being in communication with the computer system. In some examples, the association of a particular screen and a particular area of a screen is based on the geometric arrangement of the screens in a virtual and/or physical environment.

FIG. 6AJ illustrates the computer system with four screens, including first screen 630, second screen 632, third screen 634, and fourth screen 636. As illustrated in FIG. 6AJ, screens are arranged in space with first screen 630 on the left, second screen 632 on the bottom right, third screen 634 on the top right, and fourth screen 636 on the bottom left. As illustrated in FIG. 6AJ, the computer system is displaying cursor 610 on fourth screen 636. FIG. 6AJ illustrates the four screens as numbered by the computer system. FIG. 6AJ illustrates the four screens with dashed arrows to represent which screen the computer system jumps the cursor to when the computer system detects one or more predetermined inputs from the keyboard (e.g., as indicated by the direction of the arrowed lines in FIGS. 6AJ-6AK). In some examples, the computer system can jump between computer system in a different sequence than indicated by the arrowed lines in FIGS. 6AJ-6AK. In some examples, the sequence is determined based on when the screens were connected and/or how the user assigned the sequence to the screens. At FIG. 6AJ, the computer system detects one or more inputs. In some examples, the one or more inputs include a keyboard input and/or other types of inputs described herein.

As illustrated in FIG. 6AK, in response to detecting the one or more inputs, the computer system jumps cursor 610 from fourth screen 636 to first screen 630. At FIG. 6AK, no input from the mouse is needed to cause the movement cursor 610 from fourth screen 636 in FIG. 6AJ to first screen 630 in FIG. 6AK. At FIG. 6AK, the computer system does not display cursor 610 at any location between the location cursor 610 is displayed on fourth screen 636 in FIG. 6AJ, and location cursor 610 is on first screen 630 in FIG. 6AK. In some examples, the screens are arranged in a different manner, such as a line and/or a circle.

FIG. 7 is a flow diagram illustrating a method (e.g., method 700) for moving an indicator between displays in accordance with some examples. Some operations in method 700 are, optionally, combined, the orders of some operations are, optionally, changed, and some operations are, optionally, omitted.

As described below, method 700 provides an intuitive way for moving an indicator between displays. Method 700 reduces the cognitive burden on a user for moving an indicator between displays, thereby creating a more efficient human-machine interface. For battery-operated computing devices, enabling a user to move an indicator between displays faster and more efficiently conserves power and increases the time between battery charges.

In some examples, method 700 is performed at a computer system (e.g., 600) that is in communication with a first display generation component (e.g., 602, 604, 626, 630, 632, 634, and/or 636) (e.g., a display screen, a projector, and/or a touch-sensitive display), a second display generation component (e.g., 602, 604, 626, 630, 632, 634, and/or 636) different from the first display generation component (e.g., a display screen, a projector, and/or a touch-sensitive display), and one or more input devices (e.g., the keyboard and/or the mouse) (e.g., a physical input mechanism (e.g., a hardware input mechanism, a rotatable input mechanism, a crown, a knob, a dial, a physical slider, and/or a hardware button), a sensor, such as a heart rate sensor and/or gyroscope, a camera, a touch-sensitive display, a microphone, and/or a button). In some examples, the computer system is a watch, a phone, a tablet, a processor, a head-mounted display (HMD) device, and/or a personal computing device.

At 702, the computer system displays, via the first display generation component (e.g., 602, 604, 626, 630, 632, 634, and/or 636), a portion (e.g., inside of 614 and/or 618) of first content (e.g., 612 and 616) (e.g., zoom in content, one or more applications, one or more user interface, and/or one or more desktop user interfaces) and an indicator (e.g., 610 and/or 624c) (e.g., a position indicator, a cursor, an arrow, and/or a pointer) overlaid on a first location of (e.g., corresponding to, over, on, overlaid on, adjacent to, and/or on top of) the portion (e.g., inside of 614 and/or 618) of the first content (e.g., 612 and 616).

At 704, the computer system displays, via the second display generation component (e.g., 602, 604, 626, 630, 632, 634, and/or 636), a portion (e.g., inside of 614 and/or 618) of second content (e.g., 612 and 616) (e.g., zoom in content, one or more applications, one or more user interface, and/or one or more desktop user interfaces). In some examples, the first content is different from the second content. In some examples, no indicator that is the same type of indicator as indicator and/or the indicator is overlaid on the second content. In some examples, the second content is displayed at a zoom level that is different from the zoom level at which the first content is displayed. In some examples, the first display generation component is zoomed to a first zoom level and the second display generation component is zoom to a second zoom level different from the first zoom level. In some examples, the first display generation component and the second display generation component are monitors and/or displays. In some examples, the first display generation component and the second display generation component have different resolutions or the same resolutions while the first content and the second content are displayed. In some examples, the first display generation component and the second display generation component are physical displays and/or objects. In some examples, the first display generation component and the second display generation component are virtual displays and/or objects.

At 706, while displaying the indicator (e.g., 610 and/or 624c) overlaid on the first location of the portion (e.g., inside of 614 and/or 618) of first content (e.g., 612 and 616), the computer system detects, via the one or more input devices, an end of a first input (e.g., a button press, a hot key input, an air gesture/input (e.g., a first, an air tap, a release of a first, a head movement, and/or a gaze), and/or movement input (e.g., drag input and/or sliding input)) (e.g., as described above in relation to FIGS. 6F-6I, 6L-6O, and/or 6R-6U).

At 708, in response to detecting the end of the first input while displaying the indicator (e.g., 610 and/or 624c) overlaid on the first location, the computer system moves display of the indicator from overlaid (and/or from being overlaid) on the first location of the first content (e.g., 612 and 616) displayed via the first display generation component (e.g., 602, 604, 626, 630, 632, 634, and/or 636) to overlaid on (and/or to being overlaid) a second location of the second content (e.g., 612 and 616) displayed via the second display generation component (e.g., 602, 604, 626, 630, 632, 634, and/or 636) (e.g., as described above in relation to FIGS. 6F-6I, 6L-6O, and/or 6R-6U), wherein the first location of the first content is not a location corresponding to an edge of content (e.g., 612 and 616) (e.g., all and/or any content and/or content currently) displayed via the first display generation component (e.g., and/or the first content) (e.g., as described above in relation to FIGS. 6F-6I, 6L-6O, and/or 6R-6U). In some examples, the second location of the second content is not a location corresponding to an edge of content displayed via the second display generation component and/or the second content. Moving display of the indicator from overlaid on the first location that is not at the edge of content to overlaid on the second location in response to detecting the end of the first input allows the user to control the location of the display of the indicator in order to quickly move the indicator to another display without the computer system displaying a respective control and indicates to a user the state of the computer system (e.g., the computer system has detected the end of the first input), thereby providing the user with one or more additional control options without cluttering the user interface and improved visual feedback.

In some examples, detecting the end of the first input includes detecting a set of one or more keyboard inputs (e.g., a set of hotkeys, such as “command+shift+c”, “control+t,” and/or “command+y+t”) (and/or, in some examples, detecting an end of a set of one or more keyboard inputs) (e.g., as described above in relation to FIGS. 6F-6I, 6L-6O, and/or 6R-6U). In some examples, the set of one or more keyboards inputs are selected to cause the computer system to move the indicator between different location via a hotkey setting. In some examples, in response to detecting input directed to the hotkey setting, the computer system changes the hotkey to cause the computer system to move the indicator between different location via a different set of hotkeys. Moving the display of the indicator from overlaid on the first location of the first content displayed via the first display generation component to overlaid on a second location with the second content displayed via the second display generation component in response to detecting a set of one or more keyboard inputs allows the user to control the location of the display of the indicator without requiring that the computer system display a respective control, thereby providing the user with one or more additional control options without cluttering the user interface.

In some examples, detecting the end of the first input includes detecting movement of a body part (e.g., as described above in relation 6AF-6AI) (e.g., head, neck, shoulders, arms, hands, legs, and/or torso) (e.g., of a user of the computer system and/or of a non-user of the computer system) (e.g., movement of a portion of a user). In some examples, the computer system detects movement of the body part in a first direction. In some examples, the computer system detects movement of the body part, such that the computer system detects that the body part is facing a particular display generation component and/or changed from facing and/or being directed to one display generation component to being directed to another display generation component. Moving display of the indicator from overlaid on the first location of the first content displayed via the first display generation component to overlaid on a second location with the second content displayed via the second display generation component in response to detecting movement of a body part allows the user to control the location of the display of the indicator without requiring that the computer system display a respective control, thereby providing the user with one or more additional control options without cluttering the user interface.

In some examples, the first input does not correspond to (and/or does not include) a drag input or a swipe input (e.g., as described above in relation to FIGS. 6F-6I, 6L-6O, and/or 6R-6U). In some examples, the first input does not include movement of a cursor from one location to another location while holding a click input and/or a touch input against a touch sensitive surface. In some examples, the first input includes a drag input and/or a swipe input. In some examples, the first input does include movement of the cursor from one location to another location while holding the click input and/or the touch input against a touch sensitive surface.

In some examples, while displaying the indicator (e.g., 610 and/or 624c) overlaid on a first respective location (e.g., the second location and/or another location) of the second content (e.g., 612 and 616) via the second display generation component (e.g., 602, 604, 626, 630, 632, 634, and/or 636), the computer system detects an end of a second input (e.g., separate from and/or distinct from the first input) (e.g., as described above in relation to FIGS. 6L-6O and/or 6R-6U). In some examples, the respective location is another location after the computer system has moved the indicator around on the second display generation component. In some examples, in response to detecting the end of the second input while displaying the indicator overlaid on the second location, the computer system moves display of the indicator from the first respective location with the second content displayed via the second display generation component to overlay the first location of the first content (e.g., 612 and 616) displayed via the first display generation component (e.g., 602, 604, 626, 630, 632, 634, and/or 636) (e.g., as described above in relation to FIGS. 6L-6O and/or 6R-6U). In some examples, the first location of the first content displayed via the first display generation component is the last location over which the indicator was displayed before the indicator was moved from the first display generation component and/or moved from overlaid on the first location of the first content displayed via the first display generation to the second location of the second content displayed via the second display generation component. In some examples, the second input is the same type of input (e.g., hotkey input, voice command, the same hot key input, the same voice command, head movement input) as the first input. Moving display of the indicator from overlaid on the first respective location of the second content displayed via the second display generation component back to overlaid on the first location of the first content displayed via the display generation component allows a user to switch between content quickly to continue where they left off and control display location of the indicator without the computer system displaying a respective control and allows the computer system to indicate to the user a state of the computer system (e.g., the computer system detected the end of the second input), thereby providing the user with one or more additional control options without cluttering the user interface and providing improved visual feedback.

In some examples, the second display generation component (e.g., 602, 604, 626, 630, 632, 634, and/or 636) has a first zoom level. In some examples, while displaying the indicator (e.g., 610 and/or 624c) overlaid on a second respective location (e.g., the second location and/or another location) of the second content (e.g., 612 and 616) via the second display generation component and while the second display generation component has the first zoom level, the computer system detects an input (e.g., a voice input, a movement of a body part (e.g., head, torso, chin, and/or forehead) of the user forward and/or backward, a set of one or more keyboard inputs, a click and scroll input, a hold-click and scroll input, an air pinch, an air de-pinch, a pinch input, and/or a de-pinch input) corresponding to a request to change the second display generation component from having the first zoom level to having a second zoom level different from the first zoom level (e.g., as described above in relation to FIGS. 6B-6E and 6H-6M). In some examples, in response to detecting the input corresponding to the request to change the second display generation component from having the first zoom level to having the second zoom level, the computer system changes the second display generation component to have the second zoom level (e.g., including displaying the second content at a zoom level that is based on the second zoom level) (e.g., as described above in relation to FIGS. 6B-6E and 6H-6M). In some examples, changing the second display generation component to have the second zoom level includes animating display of the second content, such that the zoom level of the second content gradually changes. In some examples, while the second display generation component has the second zoom level (and, in some examples, while displaying the indicator overlaid on the second respective location and/or another location that the indicator moved to as a result of changing the zoom level of the second display generation component), the computer system detects an end of a third input (e.g., separate from and/or distinct from the first input). In some examples, in response to detecting the end of the third input, the computer system moves display of the indicator to overlay the first location of the first content (e.g., 612 and 616) displayed via the first display generation component (e.g., 602, 604, 626, 630, 632, 634, and/or 636) (e.g., as described above in relation to FIGS. 6B-6E and 6H-6M) (e.g., from the second respective location). In some examples, the indicator changes to a size that is based on the zoom level of the first display generation component after and/or while the display of the indicator is moved to overlay the first location of the first content displayed via the first display generation component. Changing the second display generation component to a second zoom level in response to detecting the input corresponding to the request to change the second display generation component from having the first zoom level to having the second zoom level allows the user to independently modify the zoom level of the second display generation component and the first display generation component without requiring that the computer system display a respective control, thereby providing the user with one or more additional control options without cluttering the user interface and providing improved visual feedback.

In some examples, while displaying the indicator (e.g., 610 and/or 624c) overlaid on a third respective location (e.g., the second location and/or another location) of the second content (e.g., 612 and 616) via the second display generation component (e.g., 602, 604, 626, 630, 632, 634, and/or 636), the computer system detects an input (e.g., an air swipe input, a swipe input, a two-finger swipe input, a three-finger swipe input, a click and drag input, a voice command, and/or input via a set of one or more hotkeys) corresponding to a request to pan the content (e.g., 612 and 616) displayed via the second display component (e.g., as described in relation to FIGS. 6L-6O). In some examples, in response to detecting the input corresponding to the request to pan the content displayed via the second display component, the computer system pans (e.g., scrolling the content, ceasing to display a portion of the content and displaying a portion of the content that was not previously displayed, and/or shifting the content to the left, right, up, and/or down) the second content (e.g., 612 and 616) displayed via the second display generation component to display a first portion (e.g., inside of 614 and/or 618) of the second content that was not previously displayed (and, in some examples, ceasing to display a second portion of the second content via the second generation component display that is different from the first portion of the second content) (and, in some examples, without panning the first content (and/or, in some examples, any content) displayed via the second display generation component) (e.g., as described in relation to FIGS. 6L-6O). In some examples, while displaying, via display second display generation component, the first portion of the first content (e.g., 612 and 616) that was not previously displayed, the computer system detects an end of a fourth input (e.g., separate from and/or distinct from the first input) (e.g., as described in relation to FIGS. 6L-6O). In some examples, in response to detecting the end of the fourth input, the computer system moves display of the indicator to overlay the first location of the first content (e.g., 612 and 616) displayed via the first display generation (e.g., from the third respective location and/or another location) (e.g., as described in relation to FIGS. 6L-6O). Panning the second content displayed via the second display generation component to display a first portion of the second content that was not previously displayed in response to detecting the input corresponding to the request to pan the content displayed via the second display component allows a user to independently control the content that is displayed via the second display generation component and the first display generation component without requiring that the computer system display a respective control, thereby providing the user with one or more additional control options without cluttering the user interface and providing improved visual feedback.

In some examples, while displaying the indicator (e.g., 610 and/or 624e) overlaid on a fourth respective location (e.g., the second location and/or another location) of the second content (e.g., 612 and 616) via the second display generation component (e.g., 602, 604, 626, 630, 632, 634, and/or 636), the computer system detects an input corresponding to a request to remove a portion (e.g., inside of 614 and/or 618) of the first content (e.g., 612 and 616) displayed via the first display generation component (e.g., as described in relation to FIGS. 6L-6O). In some examples, detecting the request to remove includes detecting an input on an exit control. In some examples, detecting the request to remove includes detecting an input directed to a representation of the portion of the first content, such as a swipe input, an air input, a gaze input, and/or a mouse input. In some examples, in response to detecting the input corresponding to the request to remove a portion of the first content displayed via the first display generation component (e.g., a request to close an application and/or a request to hide an application), the computer system ceases display of a second portion (e.g., inside of 614 and/or 618) of the first content displayed via the first display generation component (e.g., 602, 604, 626, 630, 632, 634, and/or 636) (and, in some examples, while continuing to display another portion of the first content) (e.g., as described in relation to FIGS. 6L-6O). In some examples, while second portion of the first content displayed via the first display generation component is not displayed, the computer system detects an end of a fifth input (e.g., separate from and/or distinct from the first input) (e.g., as described in relation to FIGS. 6L-6O). In some examples, in response to detecting the end of the fifth input, the computer system moves display of the indicator to overlay the first location of the first content displayed via the first display generation component (e.g., from the fourth respective location), wherein the first location is in an area of the first content in which the third portion (e.g., inside of 614 and/or 618) of the first content was previously displayed (e.g., as described in relation to FIGS. 6L-6O). Moving the display of the indicator to overlay the first location of the first content displayed via the first display generation component in response to detecting the end of the fifth input allows the user to display the indicator of a particular location of the first display generation component that is of heightened interest to the user without requiring the computer system to display a respective control, thereby providing the user with one or more additional control options without cluttering the user interface and providing improved visual feedback.

In some examples, the second location of the second content (e.g., 612 and 616) is not a location corresponding to an edge (and/or a boarder and/or a frame) (e.g., a displayed edge of the content and, in some examples, not an edge of the content that is not currently displayed) of content (e.g., 612 and 616) (e.g., all and/or any content and/or content currently) displayed via the second display generation component (e.g., 602, 604, 626, 630, 632, 634, and/or 636).

In some examples, moving display of the indicator (e.g., 610 and/or 624c) from overlaid on the first location of the first content (e.g., 612 and 616) displayed via the first display generation component (e.g., 602, 604, 626, 630, 632, 634, and/or 636) to overlaid on the second location of the second content (e.g., 612 and 616) displayed via the second display generation component (e.g., 602, 604, 626, 630, 632, 634, and/or 636) does not include displaying the indicator overlaid on a location that is not one of the first location and the second location (e.g., while moving display of the indicator from overlaid on the first location of the first content displayed via the first display generation component to overlaid on the second location of the second content displayed via the second display generation component).

In some examples, in response to detecting the end of the first input while displaying the indicator (e.g., 610 and/or 624c) overlaid on the first location and in accordance with a determination that the first input has a first movement characteristic (e.g., speed, rate, and/or acceleration), the indicator is moved with a second movement characteristic that is different from the first movement characteristic (e.g., as described in relation to FIGS. 6L-6O). In some examples, in response to detecting the end of the first input while displaying the indicator overlaid on the first location and in accordance with a determination that the first input has a third movement characteristic different from the first movement characteristic and the second movement characteristic, the indication is moved with the second movement characteristic (e.g., as described in relation to FIGS. 6L-6O). Displaying the indicator with a particular movement characteristic that is not based on the movement characteristic of the first input allows the computer system to function the same irrespective of a peed of an input to provide consistency, thereby performing an operation when a set of conditions has been met without requiring further user input.

In some examples, while displaying the indicator (e.g., 610 and/or 624c) overlaid on a fifth respective location (e.g., the second location and/or another location) of the second content (e.g., 612 and 616) via the second display generation component (e.g., 602, 604, 626, 630, 632, 634, and/or 636), the computer system detects an end of a sixth input (e.g., separate from and/or distinct from the first input) (e.g., as described in relation to FIGS. 6AJ-6AK). In some examples, the respective location is another location after the computer system has moved the indicator around on the second display generation component. In some examples, in response to detecting the end of the sixth input while displaying the indicator (e.g., 610 and/or 624c) overlaid on the second location (e.g., as described in relation to FIGS. 6AJ-6AK) and in accordance with a determination that the computer system (e.g., 600) is in communication with another display generation component (e.g., 602, 604, 626, 630, 632, 634, and/or 636) while detecting the end of the sixth input, wherein the other display generation component (e.g., 602, 604, 626, 630, 632, 634, and/or 636) is different from the first display generation component (e.g., 602, 604, 626, 630, 632, 634, and/or 636) and the second display generation component, the computer system moves display of the indicator from overlaid on the fifth respective location to overlaid on a location on the other display generation component (e.g., to a location of third content displayed on the third display generation component) (e.g., as described in relation to FIGS. 6AJ-6AK). In some examples, the location on the other display generation component is a location over which the indicator was displayed previous on the other display generation component before being moved from the other display generation component. In some examples, in response to detecting the end of the sixth input while displaying the indicator (e.g., 610 and/or 624c) overlaid on the second location (e.g., as described in relation to FIGS. 6AJ-6AK) and in accordance with a determination that the computer system (e.g., 600) is not in communication with the other display generation component (e.g., 602, 604, 626, 630, 632, 634, and/or 636) while detecting the end of the sixth input, the computer system moves display of the indicator (e.g., 610 and/or 624c) from overlaid on the fifth respective location of the second content (e.g., 612 and 616) displayed via the second display generation component to overlaid on the first location of the first content (e.g., 612 and 616) displayed via the first display generation component (e.g., as described in relation to FIGS. 6AJ-6AK). Selectively moving the display indicator from overlaid on the fifth respective location to overlaid on a particular display allows the computer system to automatically indicate to a user whether the computer system is in communication with the other display generation component, thereby performing an operation when a set of conditions has been met without requiring further user input.

In some examples, the second location is a location over which the indicator (e.g., 610 and/or 624c) was displayed via the second display generation component (e.g., 602, 604, 626, 630, 632, 634, and/or 636) before the indicator was removed from the second display generation component (e.g., as further described below in relation to method 800). Displaying the indicator overlaid on a location over which the indicator was displayed before the indicator was removed from the second display generation allows the user to display the indicator at a point of interest of the second display generation component without the computer system displaying a respective control, thereby providing the user with one or more additional control options without cluttering the user interface.

In some examples, the second location is not a location over which a gaze input (e.g., gaze of a user and/or eye gaze) has been detected (e.g., via one or more cameras (e.g., telephoto, wide-angle, ultra-wide-angle cameras) that are in communication with the computer system) (e.g., as described in relation to FIGS. 6AF-6AJ).

In some examples, the first display generation component (e.g., 602, 604, 626, 630, 632, 634, and/or 636) has a first current zoom level. In some examples, the second display generation component has a second current zoom level that is different from the first current zoom level (e.g., as described in relation to FIGS. 6V-6W). In some examples, the second current zoom level is greater than and/or less than the first current zoom level. In some examples, the computer system ceases to display a tool bar (e.g., pinned application icons, time, etc.) (e.g., 654a and/or 654b) and/or a menu bar (e.g., file, edit, folder, etc.) 654a and/or 654b). In some examples, content for an application is displayed at all edges of the display after zooming in. In some examples, after zooming in a display generation component, the computer system causes the display generation component to be zoomed out. In some examples, the computer system re-displays tool bar and/or re-displays menu bar. In some examples, content for an application content is not displayed at all edges of the display generation component after zooming out. Configuring the first display generation component and the second display generation component to have different zoom levels allows the computer system to concurrently provide content via the first display generation component and content via the second display generation component at different zoom levels and/or different resolutions, thereby providing improved visual feedback.

In some examples, moving display of the indicator (e.g., 610 and/or 624c) from overlaid on the first location of the first content (e.g., 612 and 616) displayed via the first display generation component (e.g., 602, 604, 626, 630, 632, 634, and/or 636) to overlaid on the second location of the second content (e.g., 612 and 616) displayed via the second display generation component includes changing display of the indicator from a first display size that is based on the first current zoom level to a second display size that is based on the second current zoom level. In some examples, the first display size is different from the second display size. In some examples, the first display size is greater than or less than the second display size. Displaying the indicator at a particular size based on whether the second display generation component displays the indicator or whether the first display generation component displays the indicator allows the computer system to automatically indicate to a user whether the indicator is displayed via the second display generation component or the first display generation component, thereby performing an operation when a set of conditions has been met without requiring further user input, providing improved visual feedback, and providing the user with one or more additional control options without cluttering the user interface.

In some examples, while displaying, via the second display generation component (e.g., 602, 604, 626, 630, 632, 634, and/or 636), the indicator (e.g., 610 and/or 624c) overlaid on the second location of the second content (e.g., 612 and 616) displayed via the second display generation component, the computer system detects an end of a seventh input (e.g., as described above in relation to FIGS. 6AF-6AI). In some examples, in response to detecting the end of the seventh input and in accordance with a determination that the seventh input is detected via a first type of input (e.g., head movement, keyboard input, mouse movement, and/or eye movement), the computer system moves display of the indicator (e.g., 610 and/or 624c) from the second display generation component to a display generation component (e.g., 602, 604, 626, 630, 632, 634, and/or 636) that is arranged to be adjacent (e.g., programmatically arranged, sequentially arranged, arranged to be the next display and/or previous display after and/or of the second display generation component) to the second display generation component in the environment (e.g., as described above in relation to FIGS. 6AF-6AI). In some examples, in response to detecting the end of the seventh input and in accordance with a determination that the seventh input is detected via a second type of input different from the first type of input, the computer system moves display of the indicator (e.g., 610 and/or 624e) to a display generation component (e.g., 602, 604, 626, 630, 632, 634, and/or 636) that is not arranged to be adjacent to the second display generation component in the environment (e.g., as described above in relation to FIGS. 6AF-6AI). In some examples, a display generation component is arranged between and/or positioned between the first display generation component and the second display generation component. In some examples, the display generation component is not arranged between and/or positioned between the first display generation component and the second display generation component. Moving the display of the indicator to a particular display generation component in response to detecting the end of the seventh input allows the computer system to automatically perform a display operation to indicate to the user the type of input the computer system detected, thereby performing an operation when a set of conditions has been met without requiring further user input.

Note that details of the processes described above with respect to method 700 (e.g., FIG. 7) are also applicable in an analogous manner to other methods described herein. For example, method 900 optionally includes one or more of the characteristics of the various methods described above with reference to method 700. For example, an indicator can be jumped to a previous location using method 700 and moved from the previous location using one or more operations that are selected via the techniques described in relation to method 900. For brevity, these details are not repeated below.

FIG. 8 is a flow diagram illustrating a method (e.g., method 800) for moving an indicator based on body movement in accordance with some examples. Some operations in method 800 are, optionally, combined, the orders of some operations are, optionally, changed, and some operations are, optionally, omitted.

As described below, method 800 provides an intuitive way for moving an indicator based on body movement. Method 800 reduces the cognitive burden on a user for moving an indicator based on body movement, thereby creating a more efficient human-machine interface. For battery-operated computing devices, enabling a user to move an indicator based on body movement faster and more efficiently conserves power and increases the time between battery charges.

In some examples, method 800 is performed at a computer system (e.g., 600) (that, in some examples, is in communication with one or more display generation components (e.g., a display screen and/or a touch-sensitive display)). In some examples, the computer system is a watch, a phone, a tablet, a processor, a head-mounted display (HMD) device, and/or a personal computing device. In some examples, the computer system is in communication with one or more input devices (e.g., a physical input mechanism (e.g., a hardware input mechanism, a rotatable input mechanism, a crown, a knob, a dial, a physical slider, a sensor, such as a heart rate sensor and/or gyroscope, and/or a hardware button), a camera, a touch-sensitive display, a microphone, and/or a button).

At 802, the computer system displays (e.g., via the one or more display generation components) an indicator (e.g., 610 and/or 624c) (e.g., a position indicator, a cursor, an arrow, and/or a pointer) (e.g., as described above in relation to method 700) overlaid on a first location of (e.g., as described above in relation to method 700) a first area of first content (e.g., 612 and 616) (e.g., as described above in relation to method 700).

At 804, while displaying the indicator (e.g., 610 and/or 624c) overlaid on the first location of the first area of the first content (e.g., 612 and 616), the computer system detects movement of a body part (e.g., head, neck, shoulders, arms, hands, legs, and/or torso) (e.g., of a user of the computer system and/or of a non-user of the computer system) (e.g., as described above in relation to FIGS. 6AF-6AI).

At 806, in response to detecting movement of the body part and in accordance with a determination (at 808) that the body part is directed to a first area of second content (e.g., 612 and 616) (and/or in accordance with a determination that the body part has moved in a first direction), the computer system displays the indicator (e.g., 610 and/or 624c) overlaid on a previous location of a second area of the second content (e.g., 612 and 616), wherein the indicator (e.g., 610 and/or 624c) was last displayed overlaid on the previous location of the second area of the second content (e.g., 612 and 616) before the indicator (e.g., 610 and/or 624c) was last moved from the second content (e.g., 612 and 616), and wherein a location of the first area of the second content (e.g., 612 and 616) to which the body part is detected as being directed is different from the previous location of the second area of the second content (e.g., 612 and 616) (e.g., as described above in relation to FIGS. 6AF-6AI). In some examples, the first area of the second content is different from the second area of the second content. In some examples, the first area of the second content is the same as the second area of the second content.

At 806, in response to detecting movement of the body part and in accordance with (at 810) a determination that the body portion is directed to a first area of third content (e.g., 612 and 616) (and/or in accordance with a determination that the body part has moved in a second direction direct from the first direction), the computer system displays the indicator (e.g., 610 and/or 624c) overlaid on a previous location of a second area of the third content (e.g., 612 and 616), wherein the indicator (e.g., 610 and/or 624c) was last displayed overlaid on the previous location of the second area of the third content (e.g., 612 and 616) before the indicator (e.g., 610 and/or 624c) was last moved from the third content (e.g., 612 and 616), and wherein a location of the first area of the third content (e.g., 612 and 616) to which the body part is detected as being directed is different from the previous location of the second area of the third content (e.g., 612 and 616) (e.g., as described above in relation to FIGS. 6AF-6AI). In some examples, the first area of the third content is different from the second area of the third content. In some examples, the first area of the third content is the same as the second area of the third content. Displaying the indicator overlaid on a previous location of an area of particular content based on the body portion being directed to a particular location in response to detecting movement of the body part provides a user control over where the indicator is displayed and allows the computer system to automatically disambiguate where the indicator should be displayed, thereby providing additional control options without cluttering the user interface with additional displayed controls and performing an operation when a set of conditions has been met without requiring further user input.

In some examples, in accordance a determination that a first location in the second area was the previous location of the second area of the second content (e.g., 612 and 616) before the indicator (e.g., 610 and/or 624c) was last moved from the second content and a second location in the second area was not the previous location of the second area of the second content before the indicator was last moved from the second content, the previous location is the first location (e.g., as described above in relation to FIGS. 6B-6AI). In some examples, in accordance a determination that the first location in the second area was not the previous location of the second area of the second content (e.g., 612 and 616) before the indicator was last moved from the second content and the second location in the second area was the previous location of the second area of the second content before the indicator was last moved from the second content, the previous location is the second location (e.g., as described above in relation to FIGS. 6B-6AI). Choosing the previous location where the indicator should be displayed, such that the previous location is a location that was displayed in a particular area before the indicator was moved from the particular area allows the computer system to automatically disambiguate where the indicator should be displayed and allows the computer system to display the indicator overlaid on a location that is familiar to the user, which can reduce the number of operations that the user would need to perform to move the indicator to the previous location, and thereby providing additional control options without cluttering the user interface with additional displayed controls, providing improved visual feedback, reducing the number operations needed to perform an operation, and performing an operation when a set of conditions has been met without requiring further user input.

In some examples, in response to detecting movement of the body part and in accordance with a determination that the body part is (and/or continues to be) directed to the first area of the first content (e.g., 612 and 616), the computer system continues displaying the indicator (e.g., 610 and/or 624c) overlaid on the first location of the first area of the first content (e.g., 612 and 616) (e.g., as described above in relation to FIGS. 6AF-6AI) (e.g., without displaying the indicator overlaid on another location and/or another area). In some examples, in response to detecting movement of the body part and in accordance with a determination that the body part directed to the first area of the first content, the computer system moves the indicator but, in some examples, continues to display the indicator in the first area of the first content and/or overlaid on the first content. Not moving the indicator over the first location of the first area of first content based on a determination that the body part is directed to the first area of the first content allows the computer system to automatically limit conditions at which the user did not intend to cause display of the indicator over another location, thereby reducing the number of inputs needs to perform an operation and performing an operation when a set of conditions has been met without requiring further user input.

In some examples, in response to detecting movement of the body part and in accordance a determination that the body part is (and/or continues to be) directed to a second area of the first content (e.g., 612 and 616) different from the first area of the first content (e.g., 612 and 616), the computer system continues displaying the indicator (e.g., 610 and/or 624c) overlaid on the first location of the first area of the first content (e.g., without displaying the indicator overlaid on another location and/or another area). In some examples, in response to detecting movement of the body part and in accordance with a determination that the body part is (and/or continues to be) directed to the first area of the first content different from the second area of the first content, the computer system moves the indicator but, in some examples, continues to display the indicator in the first area of the first content and/or overlaid on the first content. Continuing displaying the indicator overlaid on the first location of the first area of first content based on a determination that the body part is directed to a second area of the first content allows the computer system to automatically limit conditions at which the user did not intend to cause display of the indicator overlaid on another location, thereby reducing the number of inputs needs to perform an operation and performing an operation when a set of conditions has been met without requiring further user input.

In some examples, the computer system (e.g., 600) is in communication with a first display generation component (e.g., 602, 604, 626, 630, 632, 634, and/or 636), a second display generation component (e.g., 602, 604, 626, 630, 632, 634, and/or 636), and a third display generation component (e.g., 602, 604, 626, 630, 632, 634, and/or 636). In some examples, the first display generation component, the second display generation component, and the third display generation component are different from each other (and/or separate from each other and/or individual display generation components). In some examples, the first content (e.g., 612 and 616) is displayed via the first display generation component and is not displayed via the second display generation component and the third display generation component. In some examples, the second content (e.g., 612 and 616) is displayed via the second display generation component and is not displayed via the first display generation component and the third display generation component. In some examples, the third content (e.g., 612 and 616) is displayed via the third display generation component and is not displayed via the first display generation component and the third display generation component. Moving display of the indicator from display to a previous location on another display of an area of particular content based on the body portion being directed to a particular location in response to detecting movement of the body part provides a user control over where the indicator is displayed and allows the computer system to automatically disambiguate where the indicator should be displayed, thereby providing additional control options without cluttering the user interface with additional displayed controls and performing an operation when a set of conditions has been met without requiring further user input.

In some examples, the first area of first content (e.g., 612 and 616) is not displayed adjacent to (e.g., at, on, next, and/or near) an edge of content (e.g., 612 and 616) displayed via a first respective display generation component (e.g., 602, 604, 626, 630, 632, 634, and/or 636) (e.g., and/or edge of the first respective display generation component and/or a displayed edge of content displayed via the first respective display generation component) (e.g., while detecting movement of the body part).

In some examples, the first area of the second content (e.g., 612 and 616) is not displayed adjacent to the second area of the second content (e.g., 612 and 616). In some examples, the third area of the first content is not displayed adjacent to the third area of the third content. Displaying the indicator overlaid on a previous location of a non-adjacent area of particular content based on the body portion being directed to a particular location in response to detecting movement of the body part provides a user control over where the indicator is displayed and allows the computer system to automatically disambiguate where the indicator should be displayed, thereby providing additional control options without cluttering the user interface with additional displayed controls and performing an operation when a set of conditions has been met without requiring further user input.

In some examples, the second area of second content (e.g., 612 and 616) is not displayed adjacent to a first edge of content (e.g., 612 and 616) displayed via a second respective display generation component (e.g., 602, 604, 626, 630, 632, 634, and/or 636). In some examples, the second area of the third content (e.g., 612 and 616) is not displayed adjacent to a second edge of a third respective display generation component (e.g., 602, 604, 626, 630, 632, 634, and/or 636). In some examples, the second respective display generation component is different from the third respective display generation component. Displaying the indicator overlaid on a previous location of an area of particular content, where the previous location is not adjacent to the edge of the particular content, based on the body portion being directed to a particular location in response to detecting movement of the body part provides a user control over where the indicator is displayed and allows the computer system to automatically disambiguate where the indicator should be displayed, thereby providing additional control options without cluttering the user interface with additional displayed controls and performing an operation when a set of conditions has been met without requiring further user input.

In some examples, the first area of the second content (e.g., 612 and 616) includes at least a portion (e.g., inside of 614 and/or 618) of a first user interface. In some examples, the second area of the second content (e.g., 612 and 616) includes at least a portion (e.g., inside of 614 and/or 618) of a second user interface different from the first user interface. In some examples, a third area of the second content is displayed between the first area of the second content and the second area of the second content. In some examples, the third area of the second content includes a third user interface different from the first user interface and the second user interface. In some examples, the first area of the second content does not include the second user interface and/or the third user interface. In some examples, the second area of the second content does not include the first user interface and/or the third user interface. In some examples, the third area of the second content does not include the first user interface and/or the second user interface.

In some examples, the first area of the third content (e.g., 612 and 616) includes at least a portion (e.g., inside of 614 and/or 618) of a fourth user interface. In some examples, the second area of the third content includes at least a portion (e.g., inside of 614 and/or 618) of a fifth user interface different from the fourth user interface. In some examples, a third area of the third content is displayed between the first area of the third content and the second area of the third content. In some examples, the third area of the third content includes a sixth user interface different from the fourth user interface and the fifth user interface. In some examples, the first area of the third content does not include the fifth user interface and/or the sixth user interface. In some examples, the second area of the third content does not include the fourth user interface and/or the sixth user interface. In some examples, the third area of the third content does not include the fifth user interface and/or the sixth user interface.

In some examples, the first area of the first content (e.g., 612 and 616) is not displayed adjacent to the second area of the second content (e.g., 612 and 616). In some examples, the first area of the first content is not displayed adjacent to the second area of the third content.

In some examples, detecting movement of the body part includes detecting movement of a gaze input (e.g., a gaze of the user and/or an eye gaze of the user) from a first gaze location to a second gaze location (e.g., as described in relation to FIGS. 6AF-6AI). In some examples, the previous location of the second area of the second content (e.g., 612 and 616) does not correspond to (e.g., and/or is not) the second gaze location. In some examples, the previous location with the third area of the second content does not correspond to the second gaze location. Having the indicator move to a location that is not a location of a user's gaze allows the computer system to place the indicator over a location in content where the user is familiar without requiring the computer system to identify exactly the location over which the gaze of the user is directed to place the indicator, thereby reducing the number of inputs needed to perform an operation.

In some examples, detecting movement of the body part includes identifying that the body part has moved from a first body part location to a second body part location (e.g., as described in relation to FIGS. 6AF-6AI). In some examples, the previous location of the second area of the second content (e.g., 612 and 616) does not correspond to (e.g., and/or is not) the second body part location. In some examples, the previous location with the third area of the second content does not correspond to the second body part location. Having the indicator move to a location that is not a location of a body part allows the computer system to place the indicator over a location in content where the user is familiar without require the computer system to identify exactly the location over which the body part is directed to place the indicator, thereby reducing the number of inputs needed to perform an operation.

In some examples, the movement of the body part is detected to occur with a first movement characteristic (e.g., speed and/or acceleration). In some examples, displaying the indicator (e.g., 610 and/or 624c) overlaid on the previous location of a second area of the second content (e.g., 612 and 616) does not include moving the indicator with the first movement characteristic. Not moving the indicator with the first movement characteristic with which the body part was detected to occur allows the computer system to move the indicator at a different rate without requiring the user to move at the same rate, thereby reducing the number of inputs and/or the intensity of inputs needed to perform an operation.

In some examples, while displaying the indicator (e.g., 610 and/or 624c) overlaid on a previous location of a second area of the second content (e.g., 612 and 616), the computer system detects second movement of the body part (e.g., as described in relation to FIGS. 6AF-6AI). In some examples, in response to detecting second movement of the body part and in accordance with a determination that the body part is directed to the first location of the first area of the first content (e.g., 612 and 616), the computer system displays (and/or re-displaying) the indicator (e.g., 610 and/or 624c) overlaid on the first location of the first area of the first content (e.g., as described in relation to FIGS. 6AF-6AI). In some examples, in response to detecting second movement of the body part and in accordance with a determination that the body part is directed to the first location of the third area of the first content, the computer system displays the indicator overlaid on the previous location of the second area of the third content before the indicator was last moved from the third content. In some examples, while displaying the indicator overlaid on the previous location of the second area of the third content before the indicator was last moved from the third content, the computer system detects third movement of the body part, and the computer system re-displays the indicator overlaid on the first location of the first area of the first content. Displaying the indicator overlaid on the first location of the first area of the first content in response to detecting second movement of the body part provides a user control over where the indicator is displayed and allows the computer system to automatically disambiguate where the indicator should be displayed, thereby providing additional control options without cluttering the user interface with additional displayed controls and performing an operation when a set of conditions has been met without requiring further user input.

In some examples, in accordance with a determination that the body part is directed to the first area of second content (e.g., 612 and 616), a detected location of the body part is different from the previous location of the second area of the second content before the indicator (e.g., 610 and/or 624c) was last moved from the second content (e.g., as described in relation to FIGS. 6AF-6AI). In some examples, in accordance with a determination that the body part is directed to the first area of third content (e.g., 612 and 616), a detected location of the body part is different from the previous location of the third area of the second content before the indicator was last moved from the third content (e.g., as described in relation to FIGS. 6AF-6AI).

In some examples, one or more of the first area of the first content (e.g., 612 and 616), the second area of the second content (e.g., 612 and 616), and the second area of the third content (e.g., 612 and 616) is displayed on a virtual display (e.g., not a physical display and/or a display that is displayed and/or generated by the computer system) (e.g., as described in relation to FIGS. 6A and 6F-6AI). Displaying the indicator overlaid on a previous location of an adjacent area of particular content displayed via one or more virtual displays based on the body portion being directed to a particular location in response to detecting movement of the body part provides a user control over where the indicator is displayed on one or more virtual displays and allows the computer system to automatically disambiguate where the indicator should be displayed on one or more virtual displays, thereby providing additional control options without cluttering the user interface with additional displayed controls and performing an operation when a set of conditions has been met without requiring further user input.

In some examples, one or more of the first area of the first content (e.g., 612 and 616), the second area of the second content (e.g., 612 and 616), and the second area of the third content (e.g., 612 and 616) is displayed on a physical display (e.g., a physical display and/or a display that is not displayed and/or generated by the computer system) (e.g., as described in relation to FIGS. 6A and 6F-6AI). Displaying the indicator overlaid on a previous location of an adjacent area of particular content displayed via one or more physical displays based on the body portion being directed to a particular location in response to detecting movement of the body part provides a user control over where the indicator is displayed on one or more physical displays and allows the computer system to automatically disambiguate where the indicator should be displayed on one or more physical displays, thereby providing additional control options without cluttering the user interface with additional displayed controls and performing an operation when a set of conditions has been met without requiring further user input.

Note that details of the processes described above with respect to method 800 (e.g., FIG. 8) are also applicable in an analogous manner to other methods described herein. For example, method 900 optionally includes one or more of the characteristics of the various methods described above with reference to method 800. For example, an indicator can be jumped to a previous location using method 800 and moved from the previous location using one or more operations that are selected via the techniques described in relation to method 900.

FIG. 9 is a flow diagram illustrating a method (e.g., method 900) for managing display operations in accordance with some examples. Some operations in method 900 are, optionally, combined, the orders of some operations are, optionally, changed, and some operations are, optionally, omitted.

As described below, method 900 provides an intuitive way for managing display operations. Method 900 reduces the cognitive burden on a user for managing display operations, thereby creating a more efficient human-machine interface. For battery-operated computing devices, enabling a user to manage display operations faster and more efficiently conserves power and increases the time between battery charges.

In some examples, method 900 is performed at a computer system (e.g., 600) that is in communication with a display generation component (e.g., 602, 604, 626, 630, 632, 634, and/or 636) (e.g., a display screen and/or a touch-sensitive display) and one or more input devices (e.g., a physical input mechanism (e.g., a hardware input mechanism, a rotatable input mechanism, a crown, a knob, a dial, a physical slider, and/or a hardware button), a camera, a touch-sensitive display, a microphone, and/or a button). In some examples, the computer system is a watch, a phone, a tablet, a processor, a head-mounted display (HMD) device, and/or a personal computing device.

At 902, while operating in a first mode, the computer system displays, via the display generation component, an indicator (e.g., 610 and/or 624c) (e.g., as described above in relation to method 800 and/or an object, such as a graphical image and/or media) overlaid on content (e.g., 612 and 616) (e.g., as described above in relation to FIGS. 6T-6W).

At 904, while operating in the first mode and displaying the indicator (e.g., 610 and/or 624c) (e.g., as described above in relation to FIGS. 6J-6M), the computer system detects, via one or more input devices, a first input corresponding to a first type of input (e.g., pressing a first set of keys on a keyboard, stating a first voice command, an input that corresponds to a movement input (e.g., a swipe input and/or a drag input), a press and drag input, and/or a click and drag input) (e.g., as described above in relation to FIGS. 6T-6W).

At 906, in response to detecting the first input corresponding to the first type of input, the computer system moves display of the indicator (e.g., 610 and/or 624c) while panning (e.g., scrolling the content, ceasing to display a portion of the content and displaying a portion of the content that was not previously displayed, and/or shifting the content to the left, right, up, and/or down) the content (e.g., as described above in relation to FIGS. 6T-6W). In some examples, the computer system moves the indicator (e.g., 610 and/or 624c) and/or pans the content based on a movement characteristic (e.g., speed, direction, and/or acceleration) of the first input corresponding to the first type of input.

At 908, in conjunction with (e.g., while and/or after) moving the display of the indicator (e.g., 610 and/or 624c) while panning the content (e.g., 612 and 616), the computer system detects, via the one or more input devices, an input (and, in some examples, not corresponding to the first type of input) corresponding to a second type of input (e.g., pressing a second set of keys on a keyboard different from the first set of keys on the keyboard, stating a second voice command different from the first voice command, and/or an input that does not correspond to a movement input) different from the first type of input (e.g., as described above in relation to FIGS. 6X-6Y).

At 910, in response to detecting the input corresponding to the second type of input, the computer system configures the computer system (e.g., 600) to operate in a second mode different from the first mode input (e.g., as described above in relation to FIGS. 6X-6Y). In some examples, in response to detecting the input corresponding to the second type of input, the computer system is configured to not operate in the first mode. In some examples, in response to detecting the input corresponding to the second type of input, the computer system does not move display of the indicator (e.g., 610 and/or 624c) and/or pan the content.

At 912, while operating in the second mode (e.g., and not in the first mode), the computer system detects a second input corresponding to the first type of input (and, in some examples, not corresponding to the second type of input) input (e.g., as described above in relation to FIGS. 6Z-6AC). In some examples, the first input corresponding to the first type of input is a different input from the second input corresponding to the first input. In some examples, the first input corresponding to the first type of input is a portion of a respective input and the second input corresponding to the first type of input is another portion of the respective input.

At 914, in response to detecting the second input corresponding to the first type of input, the computer system moves the display of the indicator (e.g., 610 and/or 624c) without panning the content (e.g., 612 and 616) (e.g., as described above in relation to FIGS. 6Z-6AC). In some examples, moving the indicator (e.g., 610 and/or 624c) without panning the content includes continuing to display the content at a location while moving display of the indicator (e.g., 610 and/or 624c). Allowing a user to change between a mode in which the computer system will move the indicator without panning the content and a mode in which the computer system will move the indicator while panning the content in response to detecting an input gives a user control over the computer system to decide how the computer system will operate, thereby providing additional control options without cluttering the user interface with additional displayed controls.

In some examples, the first input corresponding to the second type of input is detected while continuing to detect the first input corresponding to the first type of input (and/or while detecting the second input corresponding to the second type of input) (e.g., as described above in relation to FIGS. 6T-6AC). In some examples, the first input corresponding to the first type of input is the same input as the second input corresponding to the first type of input. Allowing a user to change between a mode in which the computer system will move the indicator without panning the content and a mode in which the computer system will move the indicator while panning the content in response to detecting an input while another input is being detected gives a user control over the computer system to decide how the computer system will operate in a particular way even while the computer system is detecting other inputs, thereby providing additional control options without cluttering the user interface with additional displayed controls.

In some examples, the first input corresponding to the second type of input is not detected while detecting one or more of the first input corresponding to the first type of input and the second input corresponding to the first type of input (e.g., as described above in relation to FIGS. 6T-6AC). In some examples, first input corresponding to the second type of input is detected after detecting the first input corresponding to the first type of input and before detecting the second input corresponding to the first type of input. Allowing a user to change between a mode in which the computer system will move the indicator without panning the content and a mode in which the computer system will move the indicator while panning the content in response to detecting an input while another input is not being detected gives a user control over the computer system to decide how the computer system will operate in a particular way even while the computer system is not detecting other inputs, thereby providing additional control options without cluttering the user interface with additional displayed controls.

In some examples, the content (e.g., 612 and 616) is displayed at a first zoom level. In some examples, while displaying, via the display generation component (e.g., 602, 604, 626, 630, 632, 634, and/or 636), the content at the first zoom level, the computer system detects an input corresponding to a third type of input (e.g., a set of hotkeys, such as “command+shift+c”, “control+t,” and/or “command+y+t”) (and/or, in some examples, detecting an end of a set of one or more keyboard inputs) different from the first type of input and the second type of input (e.g., as described above in relation to FIGS. 6B-6E). In some examples, in response to detecting the input corresponding to the third type of input, the computer system displays, via the display generation component, the content at a second zoom level different from the first zoom level (e.g., as described above in relation to methods 700-800) (e.g., as described above in relation to FIGS. 6B-6E). In some examples, the first zoom level is greater than or less than the second zoom level. In some examples, the content is displayed at the second zoom level because the computer system changes the zoom level of the display generation component (e.g., which impacts the zoom level of the content) in response to detecting the input corresponding to the third type of input. Displaying the content at the second zoom level different from the zoom level in response to detecting the input corresponding to the third type of input gives a user control over the computer system to change the zoom level of content (and/or the display generation component), thereby providing additional control options without cluttering the user interface with additional displayed controls.

In some examples, before displaying the indicator (e.g., 610 and/or 624c) overlaid on the content, the computer system detects an input directed to a portion (e.g., inside of 614 and/or 618) of the content (e.g., 612 and 616) (e.g., a portion of the first input corresponding to the first type of input and/or a third input corresponding to the first type of input), wherein displaying the indicator includes displaying the portion of the content in response to detecting the input directed to the portion of the content.

In some examples, in response to detecting the input corresponding to the second type of input, the computer system forgoes moving display of the indicator (e.g., 610 and/or 624c). In some examples, in response to detecting the input corresponding to the second type of input, the computer system does not pan the content. Not moving the indicator in response to detecting the input corresponding to the second type of input gives a user control over the computer system to decide how the computer system will operate, thereby providing additional control options without cluttering the user interface with additional displayed controls.

In some examples, the first input corresponding to the first type of input and the second input corresponding to the first type of input are not detected at an edge of the content (e.g., 612 and 616) (e.g., as described above in relation to FIGS. 6T-6AC). In some examples, the first input corresponding to the first type of input and the second input corresponding to the first type of input are not detected at an edge of the display generation component. Allowing a user to change between a mode in which the computer system will move the indicator without panning the content and a mode in which the computer system will move the indicator while panning the content in response to detecting an input that is not detected at an edge of content gives a user control over the computer system to decide how the computer system will operate and allows a user to quickly move the cursor from one location to another location, thereby providing additional control options without cluttering the user interface with additional displayed controls.

In some examples, the computer system (e.g., 600) is in communication with a second display generation component (e.g., 602, 604, 626, 630, 632, 634, and/or 636), and wherein the second display generation component (e.g., 602, 604, 626, 630, 632, 634, and/or 636) includes second content (e.g., 612 and 616) different from the content (e.g., as described above in relation to FIGS. 6T-6AG). In some examples, while displaying, via the display generation component, the indicator (e.g., 610 and/or 624c) overlaid on the content (e.g., 612 and 616), detecting an input corresponding to a fourth type of input (e.g., a set of hotkeys, such as “command+shift+c”, “control+t,” and/or “command+y+t”) (and/or, in some examples, detecting an end of a set of one or more keyboard inputs) (e.g., as described above in relation to in relation to methods 700-800) different from the first type of input and the second type of input (e.g., as described above in relation to FIGS. 6T-6AG). In some examples, in response to detecting the input corresponding to the fourth type of input, the computer system moves display of the indicator (e.g., 610 and/or 624c) from the content displayed via the display generation component to the second content displayed via the second display generation component (e.g., as described above in relation to FIGS. 6T-6AG). In some examples, the indicator was not displayed via the second display generation component before the computer system detected the input corresponding to the fourth type of input. Moving display of the indicator from the content displayed via the display generation component to the second content displayed via the second display generation component in response to detecting the input corresponding to the fourth type of input gives a user control over the computer system to decide how the computer system will operate to move the indicator between multiple display generation components, thereby providing additional control options without cluttering the user interface with additional displayed controls.

In some examples, while operating in the second mode and after detecting the second input corresponding to the first type of input, the computer system detects a second input corresponding to the second type of input (e.g., as described above in relation to FIGS. 6T-6AC). In some examples, the second input corresponding to the second type of input is different from and/or separate from the input corresponding to the second type of input. In some examples, in response to detecting the second input corresponding to the second type of input, the computer system configures the computer system (e.g., 600) to operate in the first mode (e.g., as described above in relation to FIGS. 6T-6AC). In some examples, while operating in the first mode, the computer system detects a third input corresponding to the first type of input (e.g., as described above in relation to FIGS. 6T-6AC). In some examples, in response to detecting the third input corresponding to the first type of input, the computer system moves display of the indicator (e.g., 610 and/or 624c) while panning the content (e.g., 612 and 616) (e.g., as described above in relation to FIGS. 6T-6AC). Moving display of the indicator while panning the content in response to detecting the third input corresponding to the first type of input (e.g., an additional time) in response to detecting an input gives a user control over the computer system to decide how the computer system will operate, thereby providing additional control options without cluttering the user interface with additional displayed controls.

In some examples, the computer system (e.g., 600) is in communication with a third display generation component (e.g., 602, 604, 626, 630, 632, 634, and/or 636) different from the display generation component (e.g., 602, 604, 626, 630, 632, 634, and/or 636). In some examples, in response to detecting the first input corresponding to the first type of input, forgoing panning content (e.g., 612 and 616) displayed via the third display generation component (e.g., as described above in relation to FIGS. 6T-6AC). In some examples, in response to detecting the first input corresponding to the second type of input, the computer system does not pan the content. Not panning content displayed via the third display generation component (e.g., while panning the content on another display) in response to detecting an input gives a user control over the computer system to decide how the computer system will operate, thereby providing additional control options without cluttering the user interface with additional displayed controls.

Note that details of the processes described above with respect to method 900 (e.g., FIG. 9) are also applicable in an analogous manner to the methods described herein. For example, method 700 optionally includes one or more of the characteristics of the various methods described above with reference to method 900. For example, an indicator can be jumped to a previous location using method 700 and moved from the previous location using one or more operations that are selected via the techniques described in relation to method 900.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the management of displays. The present disclosure contemplates that in some instances, this gathered data may include personal information data that uniquely identifies or can be used to contact or locate a specific person. Such personal information data can include demographic data, location-based data, telephone numbers, email addresses, social media IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to manage displays to perform operations via inputs are based on the users' preferences, such as hot key inputs and/or body movement inputs. Accordingly, use of such personal information data enables users to have calculated control content displayed via the displays. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the cases of display management, the present technology can be configured to allow users to select to “opt in” or “opt out” of participation in the collection of personal information data during registration for services or anytime thereafter. In another example, users can select not to have body part inputs captured by one or more cameras. In yet another example, users can select to limit the length of time that body part inputs are captured by one or more cameras. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, displays can be managed by inferring preferences based on non-personal information data or a bare minimum amount of personal information, such as the content being requested by the device associated with a user, other non-personal information available to the display management processes, or publicly available information.

What is claimed is:

1. A method, comprising:
at a computer system that is in communication with a first display generation component, a second display generation component different from the first display generation component, and one or more input devices:
displaying, via the first display generation component, a portion of first content and an indicator overlaid on a first location of the portion of the first content;
displaying, via the second display generation component, a portion of second content;
while displaying the indicator overlaid on the first location of the portion of first content, detecting, via the one or more input devices, an end of a first input; and
in response to detecting the end of the first input while displaying the indicator overlaid on the first location, moving display of the indicator from overlaid on the first location of the first content displayed via the first display generation component to overlaid on a second location of the second content displayed via the second display generation component, wherein the first location of the first content is not a location corresponding to an edge of content displayed via the first display generation component.

2. The method of claim 1, wherein detecting the end of the first input includes detecting a set of one or more keyboard inputs.

3. The method of claim 1, wherein detecting the end of the first input includes detecting movement of a body part.

4. The method of claim 1, wherein the first input does not correspond to a drag input or a swipe input.

5. The method of claim 1, further comprising:
while displaying the indicator overlaid on a first respective location of the second content via the second display generation component, detecting an end of a second input; and
in response to detecting the end of the second input while displaying the indicator overlaid on the second location, moving display of the indicator from overlaid on the first respective location with the second content displayed via the second display generation component to overlaid on the first location of the first content displayed via the first display generation component.

6. The method of claim 1, wherein the second display generation component has a first zoom level, the method further comprising:
while displaying the indicator overlaid on a second respective location of the second content via the second display generation component and while the second display generation component has the first zoom level, detecting an input corresponding to a request to change the second display generation component from having the first zoom level to having a second zoom level different from the first zoom level;
in response to detecting the input corresponding to the request to change the second display generation component from having the first zoom level to having the second zoom level, changing the second display generation component to have the second zoom level;
while the second display generation component has the second zoom level, detecting an end of a third input; and
in response to detecting the end of the third input, moving display of the indicator to overlay the first location of the first content displayed via the first display generation component.

7. The method of claim 1, further comprising:
while displaying the indicator overlaid on a third respective location of the second content via the second display generation component, detecting an input corresponding to a request to pan the content displayed via the second display component;
in response to detecting the input corresponding to the request to pan the content displayed via the second display component, panning the second content displayed via the second display generation component to display a first portion of the second content that was not previously displayed;
while displaying, via display second display generation component, the first portion of the first content that was not previously displayed, detecting an end of a fourth input; and
in response to detecting the end of the fourth input, moving display of the indicator to overlay the first location of the first content displayed via the first display generation.

8. The method of claim 1, further comprising:
while displaying the indicator overlaid on a fourth respective location of the second content via the second display generation component, detecting an input corresponding to a request to remove a portion of the first content displayed via the first display generation component;
in response to detecting the input corresponding to the request to remove a portion of the first content displayed via the first display generation component, ceasing display of a second portion of the first content displayed via the first display generation component;
while second portion of the first content displayed via the first display generation component is not displayed, detecting an end of a fifth input; and
in response to detecting the end of the fifth input, moving display of the indicator to overlay the first location of the first content displayed via the first display generation component, wherein the first location is in an area of the first content in which the third portion of the first content was previously displayed.

9. The method of claim 1, wherein the second location of the second content is not a location corresponding to an edge of content displayed via the second display generation component.

10. The method of claim 1, wherein moving display of the indicator from overlaid on the first location of the first content displayed via the first display generation component to overlaid on the second location of the second content displayed via the second display generation component does not include displaying the indicator overlaid on a location that is not one of the first location and the second location.

11. The method of claim 1, wherein:
in response to detecting the end of the first input while displaying the indicator overlaid on the first location:
in accordance with a determination that the first input has a first movement characteristic, the indicator is moved with a second movement characteristic that is different from the first movement characteristic; and
in accordance with a determination that the first input has a third movement characteristic different from the first movement characteristic and the second movement characteristic, the indication is moved with the second movement characteristic.

12. The method of claim 1, further comprising:
while displaying the indicator overlaid on a fifth respective location of the second content via the second display generation component, detecting an end of a sixth input; and
in response to detecting the end of the sixth input while displaying the indicator overlaid on the second location:
in accordance with a determination that the computer system is in communication with another display generation component while detecting the end of the sixth input, wherein the other display generation component is different from the first display generation component and the second display generation component, moving display of the indicator from overlaid on the fifth respective location to overlaid on a location on the other display generation component; and
in accordance with a determination that the computer system is not in communication with the other display generation component while detecting the end of the sixth input, moving display of the indicator from overlaid on the fifth respective location of the second content displayed via the second display generation component to overlaid on the first location of the first content displayed via the first display generation component.

13. The method of claim 1, wherein the second location is a location over which the indicator was displayed via the second display generation component before the indicator was removed from the second display generation component.

14. The method of claim 1, wherein the second location is not a location over which a gaze input has been detected.

15. The method of claim 1, wherein the first display generation component has a first current zoom level, and wherein the second display generation component has a second current zoom level that is different from the first current zoom level.

16. The method of claim 15, wherein moving display of the indicator from overlaid on the first location of the first content displayed via the first display generation component to overlaid on the second location of the second content displayed via the second display generation component includes changing display of the indicator from a first display size that is based on the first current zoom level to a second display size that is based on the second current zoom level, and wherein the first display size is different from the second display size.

17. The method of claim 1, further comprising:
while displaying, via the second display generation component, the indicator overlaid on the second location of the second content displayed via the second display generation component, detecting an end of a seventh input; and
in response to detecting the end of the seventh input:
in accordance with a determination that the seventh input is detected via a first type of input, moving display of the indicator from the second display generation component to a display generation component that is arranged to be adjacent to the second display generation component in the environment; and
in accordance with a determination that the seventh input is detected via a second type of input different from the first type of input, moving display of the indicator to a display generation component that is not arranged to be adjacent to the second display generation component in the environment.

18. A non-transitory computer-readable storage medium storing one or more programs configured to be executed by one or more processors of a computer system that is in communication with a first display generation component, a second display generation component different from the first display generation component, and one or more input devices, the one or more programs including instructions for:
displaying, via the first display generation component, a portion of first content and an indicator overlaid on a first location of the portion of the first content;
displaying, via the second display generation component, a portion of second content;
while displaying the indicator overlaid on the first location of the portion of first content, detecting, via the one or more input devices, an end of a first input; and
in response to detecting the end of the first input while displaying the indicator overlaid on the first location, moving display of the indicator from overlaid on the first location of the first content displayed via the first display generation component to overlaid on a second location of the second content displayed via the second display generation component, wherein the first location of the first content is not a location corresponding to an edge of content displayed via the first display generation component.

19. A computer system that is in communication with a first display generation component, a second display generation component different from the first display generation component, and one or more input devices, comprising:
one or more processors; and
memory storing one or more programs configured to be executed by the one or more processors, the one or more programs including instructions for:
displaying, via the first display generation component, a portion of first content and an indicator overlaid on a first location of the portion of the first content;
displaying, via the second display generation component, a portion of second content;
while displaying the indicator overlaid on the first location of the portion of first content, detecting, via the one or more input devices, an end of a first input; and
in response to detecting the end of the first input while displaying the indicator overlaid on the first location, moving display of the indicator from overlaid on the first location of the first content displayed via the first display generation component to overlaid on a second location of the second content displayed via the second display generation component, wherein the first location of the first content is not a location corresponding to an edge of content displayed via the first display generation component.
